(19) United States
(12) Patent Application Publication
(10) Pub. No.: US 2026/0287255 A1
(43) Pub. Date: Sep. 24, 2026

(54) SYSTEMS AND METHODS FOR DIRECT REDUCTION OF IRON ORE

(71) Applicant: UCHICAGO ARGONNE, LLC, Chicago, IL (US)

(72) Inventors: Pingping Sun, Downers Grove, IL (US); Yi Ran Lu, Lemont, IL (US)

(21) Appl. No.: 19/573,969

(22) Filed: Mar. 20, 2026

Related U.S. Application Data
(60) Provisional application No. 63/775,611, filed on Mar. 21, 2025.

(51) Int. Cl. F27B 1/22; C21B 13/00; C21B 13/02; F27B 1/24; F27D 9/00; F27D 17/13

(52) U.S. Cl. CPC F27B 1/22; C21B 13/0073; C21B 13/029; F27B 1/24; F27D 17/13; C21B 2100/40; C21B 2300/02; F27D 2009/0072

(57) ABSTRACT

Methods and systems of the disclosure provide for direct reduction of iron with hydrogen using one or more means for achieving the temperatures within the shaft furnace including, preheating of the hydrogen, combustion with oxygen within the shaft furnace, and/or electric heating of the shaft furnace. The methods and systems of the disclosure advantageously allow for tailoring to a desired hydrogen, oxygen, and electricity consumption.

### CROSS-REFERENCE TO RELATED APPLICATION

The benefit of priority to U.S. Provisional Patent Application No. 63/775,611 filed Mar. 21, 2025 is hereby claimed and the disclosure is incorporated herein by reference in its entirety.

### STATEMENT OF GOVERNMENT SUPPORT

This invention was made with government support under Contract No. DE-AC02-06CH11357 awarded by the United States Department of Energy to UChicago Argonne, LLC, operator of Argonne National Laboratory. The government has certain rights in the invention.

### FIELD

The disclosure relates to methods and systems for the direct reduction of iron within a shaft furnace.

### BACKGROUND

The iron and steel industry accounts for 5% of the global energy consumption and 7% of the global greenhouse gas emissions. The traditional route of producing steel is using the blast furnace-basic oxygen furnace (BF-BOF) process, which requires high temperature and high usage of coal/coke. These materials have high carbon intensity upon oxidation via combustion or reduction reaction, leading to high energy demands and extensive greenhouse gas emissions-approximately 2 metric tons (MT) CO₂ equivalent per MT of steel produced. https://www.sciencedirect.com/science/article/pii/S1750583623001287.

Alternatively, steel can be produced using a newer technology called direct reduced iron (DRI), which has been gaining popularity globally with its ease of operation and lower production costs. However, the conventional DRI processes still rely on coal or natural gas to generate syngas (mixture of carbon monoxide and hydrogen, or CO and H₂) required for iron ore reduction. In conventional DR process, the reducing gas entering the furnace (known as bustle gas) is reformed from natural gas containing hydrogen and CO and is heated up to reducing temperature (>760° C.). Due to thermodynamic limitations, the reducing gas after passing through the reduction zone (known as top gas) contains unreacted H₂ and CO a portion of the top gas is used as the fuel source for the heating and reforming requirement. Thus the reducing gas often carries out a dual function as the reductant and energy source (e.g. providing heat via combustion). Conventionally, DRI processes are done in a shaft furnace, using counterflow syngas fed from the bottom of the furnace, obtained from a reformed natural gas or coal. Iron does not reach melting point in the shaft furnace, but rather is reduced to metal as a solid.

### SUMMARY

Using pure hydrogen generated from low-carbon sources to replace syngas in a DRI process can significantly reduce the carbon emissions associated with steel production. However, iron ore reduction using hydrogen is more endothermic than syngas-based reduction (which contains carbon monoxide, an exothermic reductant) necessitating new methods of providing heat within the direct reduction furnace.

Methods of the disclosure advantageously provide a DRI process in which the syngas is entirely replaced by H₂ to eliminate greenhouse gas emission, enhance overall energy efficiency, increase reaction rates, and improve fuel flexibility. In methods of the disclosure, iron ore is fed into a shaft furnace from the top and heated. The ore descends through the shaft furnace and is reduced by counter-current flow of optionally preheated hydrogen fed into a reduction zone of the furnace. Gas flowing out of the reduction zone can be utilized for preheating the incoming ore. Direct reduced iron exiting the reduction zone is then cooled by an inflow of cooling hydrogen gas through heat exchange in the cooling zone. After heat exchange with exiting direct reduced iron, the now-heated cooling hydrogen gas flows into the reduction zone to be used for reduction. Oxygen can be optionally injected near the top of the furnace to provide additional heat through combustion inside the furnace.

In accordance with embodiments of the disclosure, a method for producing direct reduced iron (DRI) using a shaft furnace comprising a heating zone, a reduction zone, and a cooling zone cam include: loading iron ore into a furnace at the heating zone, wherein the iron ore is heated to a target temperature; flowing a bustle gas comprising hydrogen gas into the furnace through a bustle gas inlet disposed at a downstream end of the reduction zone; flowing oxygen and/or an oxygen enriched gas into the shaft furnace through an oxygen inlet disposed upstream of the bustle gas inlet, wherein a portion of the hydrogen combusts with the oxygen within the shaft furnace and releases heat internally within the shaft furnace; flowing the iron ore from the heating zone into the reduction zone, wherein the iron ore is reduced to iron through reaction of the iron ore with the hydrogen, thereby producing direct reduced iron (DRI); flowing a cooling hydrogen gas into the cooling zone; and flowing the direct reduced iron (DRI) from the reduction zone into the cooling zone to cool the direct reduced iron by heat exchange with the cooling hydrogen gas, wherein the cooling hydrogen gas, after heat exchange with the direct reduced iron (DRI) flows into the reduction zone, wherein hydrogen and formed steam present in the shaft furnace from the bustle gas and/or cooling gas flows from the cooling and/or reduction zones upstream into the heating zone to heat the iron ore through heat exchange before exiting as a top gas.

In accordance with embodiments of the disclosure, a method for producing direct reduced iron (DRI) using a shaft furnace comprising a heating zone, a reduction zone, and a cooling zone can include: loading iron ore into a furnace at the heating zone, wherein the iron ore is heated to a target temperature; flowing a bustle gas comprising hydrogen into the shaft furnace at a downstream end of the reduction zone, wherein the bustle gas is preheated without combustion of the hydrogen to a temperature of about 650° C. to about 1100° C. before being flowed into the shaft furnace, and flows within the shaft furnace through the reduction zone and into the heating zone; optionally flowing a heat carrier gas into the shaft furnace at the downstream end of the reduction zone, wherein the heat carrier gas comprises an inert gas and is preheated to a temperature of about 650° C. to about 1100° C. before being flowed into the shaft furnace; flowing the iron ore from the heating zone into the reduction zone, wherein the iron ore is reduced to iron through reaction of the iron ore with the preheated bustle gas, thereby producing direct reduced iron (DRI); flowing a cooling hydrogen gas into the cooling zone; and flowing the direct reduced iron (DRI) from the reduction zone into the cooling zone to cool the direct reduced iron by heat exchange with the cooling hydrogen gas, wherein the cooling hydrogen gas, after heat exchange with the direct reduced iron (DRI) flows into the reduction zone, wherein: a molar ratio of H₂:Fe₂O₃ of about 7 mol/mol is a minimum hydrogen demand for a target 95% metallization of iron from the iron ore at 950° C., when the heat carrier gas is not present, the preheated bustle gas is flowed into the shaft furnace such that an amount of hydrogen within the reduction zone is greater than the minimum hydrogen demand, when the heat carrier gas is present, the bustle gas is flowed into the shaft furnace such that an amount of hydrogen within the reduction zone is equal to or greater than the minimum hydrogen demand, and wherein hydrogen present in the shaft furnace flows from the cooling and/or reduction zones upstream into the heating zone to heat the iron ore through heat exchange before exiting as a top gas, and optionally, when present, the heat carrier gas flows from the reduction zone upstream into the heating zone to heat the iron ore through heat exchange before exiting with the top gas.

In accordance with embodiments of the disclosure, a method for producing direct reduced iron using a shaft furnace comprising a heating zone, a reduction zone, and a cooling zone, can include: loading iron ore into a furnace at the heating zone, wherein the iron ore is heated to a target temperature; flowing a bustle gas comprising hydrogen into the shaft furnace at downstream end of the reduction zone, flows upstream through the reduction zone towards the heating zone; electrically heating the shaft furnace in at least the reduction zone to a temperature of about 800° C. to about 1100° C.; flowing the iron ore from the heating zone into the reduction zone, wherein the iron ore is reduced to iron through reaction of the iron ore with the hydrogen in the bustle gas, thereby producing direct reduced iron; flowing a cooling hydrogen gas into the cooling zone; and flowing the direct reduced iron from the reduction zone into the cooling zone to cool the direct reduced iron by heat exchange with the cooling hydrogen gas, wherein the cooling hydrogen gas, after heat exchange with the direct reduced iron is flowed into the reduction zone, wherein hydrogen present in the shaft furnace from the bustle gas and/or the cooling hydrogen gas is flowed from the cooling and/or reduction zones upstream into the heating zone to heat the iron ore through heat exchange before exiting as a top gas.

In accordance with embodiments of the disclosure, a system for producing direct reduced iron, can include: a shaft furnace a heating zone, a reduction zone, and a cooling zone; an iron ore source in fluid communication with the heating zone to load iron ore into the heating zone; a bustle gas source for flowing a bustle gas comprising hydrogen into the shaft furnace through a bustle gas inlet disposed at a downstream end of the reduction zone; an oxygen source for flowing oxygen and/or oxygen enriched gas into the shaft furnace an oxygen inlet disposed upstream of the bustle gas inlet, wherein a portion of the hydrogen flowed into shaft furnace is adapted to combust upon exposure to the oxygen and/or oxygen enriched gas flowed into the shaft furnace and release heat internally within the shaft furnace; and a cooling hydrogen gas source for flowing cooling hydrogen gas into the shaft furnace through cooling hydrogen gas inlet disposed in the cooling zone, wherein: the iron ore is adapted to be flowed downstream from the heating zone to the reduction zone, wherein upon interaction with hydrogen in the reduction zone the iron ore is reduced to iron by reaction with the hydrogen and to thereby produce direct reduced iron, the direct reduced iron produced in the reduction zone is adapted to be flowed downstream to the cooling zone wherein it is cooled by heat exchange with the cooling hydrogen gas, and hydrogen present in the shaft furnace from the bustle gas and/or the cooling hydrogen gas is adapted to flow from the cooling and/or reduction zones upstream into the heating zone to heat the iron ore through heat exchange before exiting as a top gas.

In accordance with embodiments of the disclosure a system for producing direct reduced iron, can include: a shaft furnace a heating zone, a reduction zone, and a cooling zone; an electric heater disposed on or integral with the shaft furnace for heating the shaft furnace to a temperature of about 800° C. to about 1100° C. in at least the reduction zone; an iron ore source in fluid communication with the heating zone to load iron ore into the heating zone; a bustle gas source for flowing a bustle gas comprising hydrogen into the shaft furnace through a bustle gas inlet disposed at a downstream end of the reduction zone; a cooling hydrogen gas source for flowing cooling hydrogen gas into the shaft furnace through cooling hydrogen gas inlet disposed in the cooling zone, wherein: the iron ore is adapted to be flowed downstream from the heating zone to the reduction zone, wherein upon interaction with hydrogen in the reduction zone the iron ore is reduced to iron by reaction with the hydrogen and to thereby produce direct reduced iron, the direct reduced iron produced in the reduction zone is adapted to be flowed downstream to the cooling zone wherein it is cooled by heat exchange with the cooling hydrogen gas, and hydrogen present in the shaft furnace from the bustle gas and/or cooling hydrogen gas is adapted to flow from the cooling and/or reduction zones upstream into the heating heat zone to heat the iron ore through heat exchange before exiting as a top gas.

In accordance with embodiments of the disclosure, a system for producing direct reduced iron, can include: a shaft furnace a heating zone, a reduction zone, and a cooling zone; an iron ore source in fluid communication with the heating zone to load iron ore into the heating zone; a bustle gas source for flowing bustle gas comprising hydrogen into the shaft furnace through a bustle gas inlet disposed at a downstream end of the reduction zone; optionally a heat carrier gas source for flowing a heat carrier gas comprising an inert gas into the shaft furnace through a heat carrier gas inlet loaded at a downstream end of the reduction zone or through the bustle gas inlet; a bustle gas preheating unit arranged between the bustle gas source and the bustle gas inlet, wherein the bustle gas preheating unit is adapted to preheat the bustle gas without combustion of the hydrogen to a temperature of about 650° C. to about 1100° C.; optionally a heat carrier gas inlet arranged between the heat carrier gas source and the heat carrier gas inlet or bustle gas inlet through which the heat carrier gas is flowed into the shaft furnace, wherein the heat carrier gas preheating unit preheats the heat carrier gas to a temperature of about 650° C. to about 1100° C.; a cooling hydrogen gas source for flowing cooling hydrogen gas into the shaft furnace through cooling hydrogen gas inlet disposed in the cooling zone, wherein: the iron ore is adapted to be flowed downstream from the heating zone to the reduction zone, wherein upon interaction with hydrogen in the reduction zone the iron ore is reduced to iron by reaction with the hydrogen and to thereby produce direct reduced iron, the direct reduced iron produced in the reduction zone is adapted to be flowed downstream to the cooling zone wherein it is cooled by heat exchange with the cooling hydrogen gas, and a molar ratio of H₂:Fe₂O₃ of about 7.4 mol/mol is a minimum hydrogen demand for a target 95% metallization of iron from the iron ore at 950° C., when the heat carrier gas is not present, the preheated bustle gas is adapted to be flowed into the shaft furnace such that an amount of hydrogen in the reduction zone is greater than the minimum hydrogen demand, when the heat carrier gas is present, the bustle gas is flowed into the shaft furnace such that an amount of hydrogen in the reduction zone is equal to or greater than the minimum hydrogen demand, and hydrogen present in the shaft furnace from the bustle gas and/or cooling hydrogen gas is adapted to flow from the cooling and/or reduction zones upstream into the heating zone to heat the iron ore through heat exchange before exiting as a top gas, and optionally when present, the heat carrier gas is adapted to flow from the reduction zone upstream into the heating zone to heat the iron ore through heat exchange before exiting with the top gas.

### BRIEF DESCRIPTION OF THE DRAWINGS

FIGS. 1A-1D are schematic illustrations of systems in accordance with the disclosure for performing methods in accordance with the disclosure.

FIG. 2 is a graph showing metallization as a function of oxygen injection rate for a system and method as depicted in FIG. 1A with various H₂:Fe₂O₃ molar ratio.

FIG. 3 is a graph showing temperature as a function of distance from the top of the shaft furnace for a system and method depicted in FIG. 1A, with an oxygen injection rate of 100 mol/s.

FIG. 4 is a graph showing the oxidation state of iron as a function of distance from the top of the reduction zone for a system and method depicted in FIG. 1A, with an oxygen injection rate of 100 mol/s.

FIG. 5 is a graph showing the mole fraction of hydrogen and water in the gas phase as a function of distance from the top of the reductio zone for a system and method depicted in FIG. 1A, with an oxygen injection rate of 100 mol/s.

FIG. 6 is a graph showing reaction rate of each step in iron ore reduction as a function of distance from the top of the reduction zone for a system and method depicted in FIG. 1A, with an oxygen injection rate of 100 mol/s.

FIG. 7 is a graph showing temperature profiles of bustle gas flow in the furnace as a function of distance from the top of the furnace, with various H₂:Fe₂O₃ molar ratio and corresponding iron metallization labeled, for a system and method depicted in FIG. 1B.

FIG. 8 is a graph showing the temperature as a function of distance from the top of the shaft furnace for a system and method depicted in FIG. 1B, with H₂:Fe₂O₃=11.1, a hydrogen flow of 1.5× minimum hydrogen demand.

FIG. 9 is a graph showing the oxidation state as a function of distance from the top of the reduction zone for a system and method depicted in FIG. 1B, with H₂:Fe₂O₃=11.1, a hydrogen flow of 1.5× minimum hydrogen demand.

FIG. 10 is a graph showing the mole fraction of hydrogen and water in the gas phase as a function of distance from the top of the reduction zone for a system and method depicted in FIG. 1B, with H₂:Fe₂O₃=11.1, a hydrogen flow of 1.5× minimum hydrogen demand.

FIG. 11 is a graph showing the reaction rate of each step in iron ore reduction as a function of distance from the top of the reduction zone for a system and method depicted in FIG. 1B, with H₂:Fe₂O₃=11.1, a hydrogen flow of 1.5× minimum hydrogen demand.

FIG. 12 is a graph showing the molar ratio of hydrogen to iron oxide as a function of electric heating power for a system and method depicted in FIG. 1C.

FIG. 13 is a graph showing the temperature profile as a function of distance from the top of the reduction zone for a system and method depicted in FIG. 1C, with 25 KW electric heating power.

FIG. 14 is a graph showing the oxidation state of iron as a function of distance from the top of the reduction zone for a system and method depicted in FIG. 1C, with 25 KW electric heating power.

FIG. 15 is a graph showing the mole fraction of hydrogen and water in the gas phase as a function of distance from the top of the reduction zone for a system and method as shown in FIG. 1C, with 25 KW electric heating power.

FIG. 16 is a graph showing reaction rates at each step in iron ore reduction as a function of distance from the top of the reduction zone for a system and method as shown in FIG. 1C, with 25 KW electric heating power.

### DETAILED DESCRIPTION

Systems and methods of the disclosure provide for direct reduced iron within a shaft furnace using hydrogen gas countercurrent to the flow of iron ore. These systems and methods of the disclosure advantageously provide means to use hydrogen, oxygen, and electricity efficiently and can be tailored to achieve desired levels of hydrogen, oxygen, and electricity consumption.

Direct reduction of iron within a shaft furnace occurs through the interaction of hydrogen and iron ore at elevated temperatures. Direct reduction of iron advantageously does not require melting of the iron ore. The methods and systems of the disclosure operate at temperatures of 600° C. to 1100° C. in the reduction zone, for example about 950° C. to about 1100°, or about 600° C. to 1000° C., or any values or ranges between 600° C. and 1100° C. Elevation of the temperature within the reduction zone can be accomplished via various mechanisms described herein. The flexibility advantageously allows tailoring of the systems and methods to achieve specific targets of hydrogen, oxygen, and energy consumption for economic and environmental considerations.

### Methods of the Disclosure

In each method and system described herein, direct reduction of iron is performed in a shaft furnace comprising a heating zone, a reduction zone, and a cooling zone. Relative to the direction of iron ore flow through the shaft furnace, the heating zone is located at the upstream-most end where iron ore is introduced, while the cooling zone is located at the downstream-most end where direct reduced iron (DRI) is collected. The reduction zone is positioned between these two zones. As used herein, “upstream” and “downstream” refer to the direction of iron ore flow through the furnace.

Generally, disclosed methods involve direct reduction of iron in the reduction zone by interaction between iron ore and a reducing gas (“bustle gas”). The bustle gas flows countercurrent to the iron ore flow direction through the shaft furnace. In these methods, direct reduction occurs through reaction with bustle gas containing hydrogen as a reducing agent. For example, bustle gas may include hydrogen as its sole reducing agent; it can consist essentially or entirely of hydrogen. A bustle gas consisting entirely of hydrogen may contain moisture and optionally include or be mixed with an inert gas (e.g., as a heat carrier). Due to thermodynamic equilibrium limitations (H₂/H₂O/FeO/Fe equilibrium), the maximum theoretical degree of hydrogen utilization is approximately 38% at 950° C. Although stoichiometrically 3 moles H₂ per mole Fe₂O₃ are required for complete reduction, equilibrium constraints dictate that achieving about 95% metallization requires at least 7.4 moles H₂ per mole Fe₂O₃ in practice. This molar ratio (7.4 moles H₂ per mole Fe₂O₃) is referred to herein as “minimum hydrogen demand.” After direct reduction in the reduction zone, reduced iron flows into the cooling zone, while bustle gas moves upward into the heating zone before exiting as “top gas.” Under typical operating conditions, top gas contains approximately 4 moles unreacted H₂ per mole Fe₂O₃ fed into the furnace and up to about 38% water vapor by volume. The top gas may also contain dust and other impurities that can be separated for recovery and recycling of hydrogen. As detailed below, certain embodiments include an inert heat carrier gas that exits through top gas; this inert gas can also be separated from hydrogen for recycling back into the system. After cooling in the cooling zone, direct reduced iron can be removed from the shaft furnace.

In each of the methods of the disclosure, the iron ore, also known as burden, is loaded into the heating zone of the shaft furnace. The iron ore can be preheated in the heating zone. The iron ore can be preheated to an elevated temperature, e.g. of about 400° C. to about 700° C. Preheating can be accomplished through heat exchange with, for example, bustle gas flowing out of the reduction zone and/or through input of heat into the heating zone, such as for example through electric heating or plasma heating.

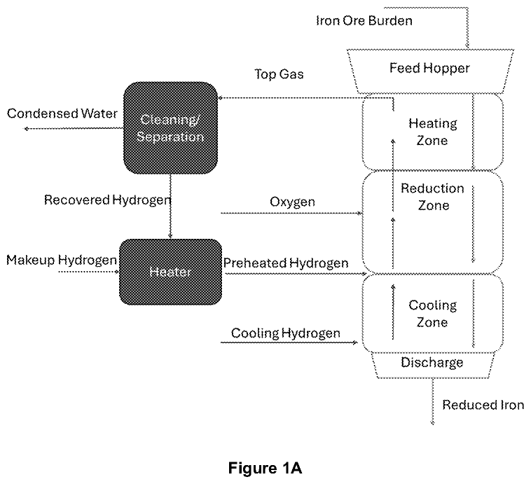

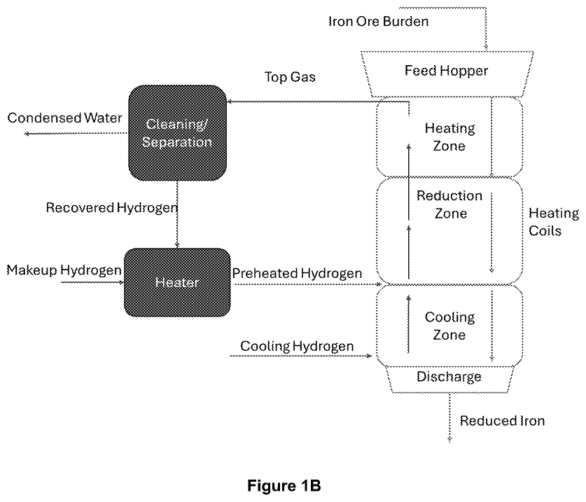

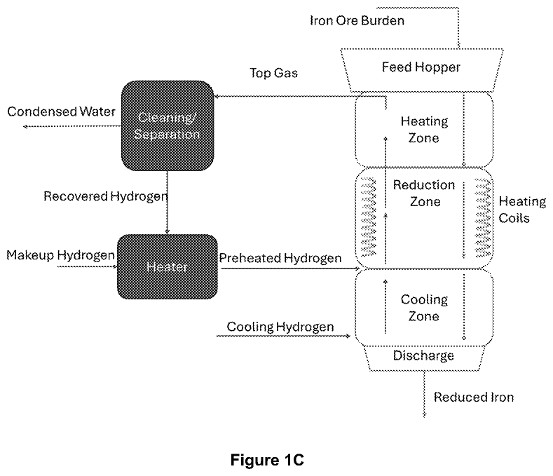

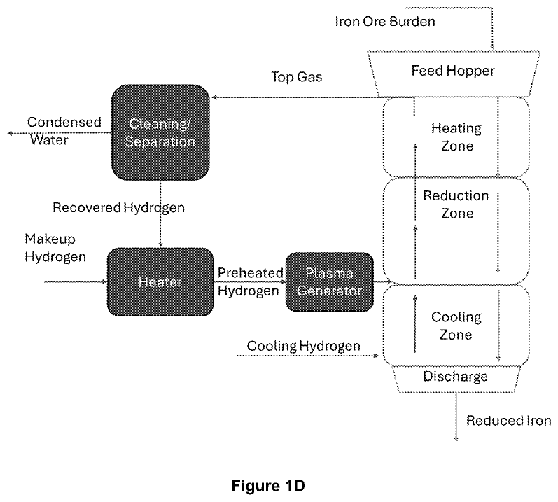

Referring to FIG. 1A, in embodiments of the methods of the disclosure, hydrogen containing bustle gas is flowed into the shaft furnace at a bustle gas inlet located at a downstream end of the reduction zone. The bustle gas can optionally be preheated before being flowed into the shaft furnace. For example, the bustle gas can be preheated by a single-stage or multi-stage heating process to a temperature of about 500° C. to 1100° C. before being flowed into the shaft furnace through the bustle gas inlet. Any known heating equipment and processes can be used. The method can further include flowing oxygen or an oxygen-enriched gas into the reduction zone through an oxygen inlet upstream of the bustle gas inlet. For example, oxygen can be injected at high pressure through one or multiple ports located inside the reduction zone upstream of the bustle gas inlet. A portion of the hydrogen in the bustle gas reacts with the oxygen within the reduction zone and combusts to release heat inside the reduction zone of the shaft furnace. The combustion can generate a sufficient amount of heat to raise the temperature within the reduction zone to a temperature of at least 760° C., which is the minimum temperature necessary for reduction of the iron ore by hydrogen. The method includes flowing the iron ore into the reduction zone, where it interacts with the counterflowing hydrogen from the bustle gas to thereby reduce iron in the iron ore and produce the direct reduced iron. The direct reduced iron is then flowed from the reduction zone into the cooling zone for cooling. The cooled direct reduced iron can be collected from the cooling zone.

Referring to FIG. 1B, in some embodiments, the method includes flowing the hydrogen containing bustle gas and optionally a heat carrier gas into the shaft furnace at a bustle gas inlet located at a downstream end of the reduction zone. The bustle gas can be preheated to an elevated temperature, e.g. of about 600° C. to about 1100° C. The heat carrier gas, when present, can be similarly preheated to a temperature of about 600° C. to about 1100° C. The heat carrier gas can include, for example, an inert gas. The heat carrier gas can include any inert gas, for example nitrogen and/or argon. The heat carrier gas when present can be flowed into the shaft furnace at a separate heat carrier gas inlet or can be premixed with the bustle gas and flowed into the shaft furnace through the bustle gas inlet. The heat carrier gas, when present, can be preheated in a heat carrier gas preheating unit separate from the bustle gas preheating unit or can be preheated in the same preheating unit as the bustle gas. The bustle gas and heat carrier gas (when present) can be heated to a temperature and flowed into the reduction zone at a sufficient rate to maintain the reduction zone at a temperature sufficient for reduction of the iron ore by hydrogen. The carrier gas is not consumed in the process. The bustle gas (hydrogen) is not combusted. The top gas containing the carrier gas, the remaining reducing agent in the bustle gas, is separated from the steam by condensation and recirculated back into the inlet. The method as shown in FIG. 1B, further includes flowing iron ore into the reduction zone, where it reacts with a counterflow of hydrogen from the bustle gas. Heat from the bustle gas and/or the heat carrier gas can supply sufficient heat for the reduction reaction to occur and buffer the temperature drop as heat is absorbed by the hydrogen reaction to maintain a sufficient temperature within the reduction zone to achieve target metallization of the burden. As with the other embodiments of methods of the disclosure, after reduction, the direct reduced iron is then flowed from the reduction zone into the cooling zone for cooling. The cooled direct reduced iron can be collected from the cooling zone.

In embodiments, the heat carrier gas is not present and the heat is supplied from the bustle gas alone. In such embodiments, the bustle gas is flowed into the reduction zone such that the amount of hydrogen is greater than the minimum hydrogen demand for reduction of the iron ore. For example, when the heat necessary for reduction is supplied entirely from the bustle gas, without the inert heat carrier gas, the bustle gas can be flowed into the reduction zone such an additional 4-9 moles H₂ per mole of Fe₂O₃ in excess of the minimum hydrogen demand is present in the reduction zone to provide heat when the heat necessary for the reduction reaction. For example, the bustle gas can be flowed into the shaft furnace to about 1.25 to 2 times the amount of minimum hydrogen demand. All or at least a portion of non-reacted H₂ supplied in the bustle gas for heating purpose can be recovered and recycled into the system through the top gas.

In embodiments in which a heat carrier gas is added to the bustle gas for providing sufficient heat, the inert gas can be provided in a sufficient amount to maintain the temperature requirements for reduction and a minimum hydrogen demand amount of hydrogen can be flowed into the shaft furnace. For example, an additional (e.g., 4-9 moles of) inert gas per mole of Fe₂O₃ can be provided to the reduction zone for supplying the necessary heat and a minimum hydrogen demand amount can be used. Alternatively, the bustle gas can include additional hydrogen in excess of the minimum demand in combination with additional moles of inert gas to supply the requisite heat necessary for the reduction reaction. The expectation in the art is that the inclusion of the heat carrier gas would adversely affect the reduction by reducing the H₂ partial pressure. However, it was beneficially found that as a result of the inert heat carrier gas carrying more heat and allowing for higher temperatures within the reduction zone and/or maintenance of higher temperatures within the reduction zone, the decrease in iron ore reduction kinetics due to lower H₂ partial pressure can be offset. It has also been advantageously found that in addition to adding heat to the reduction zone, adding inert gas can also modify the combustion characteristics of the reducing gas. For example, an inert gas can act as a heat buffer which reduces formation of hot spots within the reduction zone, promoting a more uniform temperature distribution. This can prevent the overheating of localized areas and improve the efficiency of the reduction process. Moreover, the inert gas can help maintain the stability of the gas composition in the reduction zone, ensuring a more controlled and consistent reaction environment. Additionally, the use of a controlled heat carrier gas flow can also dilute H₂ stream within the shaft furnace, and, thus, relax the requirement on material compatibility (for pure H₂ handling) and potentially improve the operation safety of the process and extend the operational life of the reduction furnace by mitigating temperature-related wear and tear on furnace materials.

Referring to FIG. 1C, in some embodiments, bustle gas comprising hydrogen is flowed into the shaft furnace at a bustle gas inlet located at a downstream end of the reduction zone. The method can further include flowing the iron ore into the reduction zone, where it interacts with the counterflowing hydrogen to thereby reduce iron in the iron ore and produce the direct reduced iron. The shaft furnace in at least the reduction zone can be electrically or thermally heated to a temperature sufficient for reduction. In these embodiments, heating is accomplished without the combustion of hydrogen. For example, resistive heaters can be disposed on and/or embedded within the internal walls of the shaft furnace in at least the reduction zone. For example, induction coils can be wrapped around the shaft furnace in at least the reduction zone. Any known electric heating methods or combination of methods can be used to electrically heat the shaft furnace in at least the reduction zone. The method can be used in conjunction with preheating of the hydrogen, in which the electrical heating will sustain the temperature of the reduction above the point necessary for the reduction of the iron ore by hydrogen (760° C.). The direct reduced iron is then flowed from the reduction zone into the cooling zone for cooling. The cooled direct reduced iron can be collected from the cooling zone.

Each of the methods as shown in FIGS. 1A-1C utilize different methods for achieving the necessary temperature within the shaft furnace at the reduction zone. Any of the methods for achieving the necessary temperature in the methods described herein can be used. For example, oxygen/hydrogen combustion such as in FIG. 1A can be used in combination with the preheating and excess flow of hydrogen and/or the use of a heat carrier gas such as described above with reference to FIG. 1B and electrical heating of the shaft furnace such as described above with reference to FIG. 1C. For example, the preheating and excess flow of hydrogen and/or the use of a heat carrier gas such as described above with reference to FIG. 1B can be used with the electrical or thermal heating of the shaft furnace such as described above with reference to FIG. 1C. This allows the methods of the disclosure to be tailored to achieve target levels of consumption of hydrogen, oxygen, electricity, and thermal energy. For example, electricity can be conserved in methods as shown in FIG. 1A, where heat is generated through the combustion of hydrogen and oxygen. However, higher hydrogen and oxygen consumption may be needed as compared to, for example, the method as shown in FIG. 1C, which relies upon electric heating. To lower oxygen and hydrogen consumption that may be needed in a method such as the embodiment in FIG. 1A, for example, the method can be combined with electric heating of the shaft furnace and/or preheating of the hydrogen before flowing hydrogen into the shaft furnace through the bustle gas inlet. For example, methods such as the embodiment in FIGS. 1B and 1C rely upon high electrical consumption for preheating the hydrogen and/or electrically heating the shaft furnace. To reduce electrical consumption, oxygen can be introduced as in the method of FIG. 1A to generate heat with the combustion of hydrogen with the oxygen within the shaft furnace. This can allow less electrical energy to be used for heating as compared to methods of FIGS. 1B and 1C. Similarly, in methods of FIG. 1A, hydrogen consumption can be reduced by supplementing the heating with electrical means, such as through preheating the hydrogen and/or electrically heating the shaft furnace in at least the reduction zone, in order to reduce or even avoid consumption of hydrogen through hydrogen combustion. For example, embodiments of the method such as in FIG. 1B have higher bustle gas requirements as compared to the other methods, as a requirement of excess preheated bustle gas is needed to carry sufficient heat within the reduction zone. The requirement within the method of FIG. 1B can be reduced, for example, by introducing another heat source, such as the heat carrier gas and/or electric or thermal heating of the reduction zone. An alternative heat source, such as molten salt, or nuclear thermal output can be used for preheating instead of or in combination with electricity. Thus bustle gas flow rate, consumption, and cost can be reduced, for example, by electrically heating the shaft furnace in the reduction zone. The bustle gas flow rate and compressor size may also be reduced in a method such as FIG. 1B by increasing electricity consumption and heating the bustle gas in the preheating stage to a higher temperature, closer to the 1000° C. end of the temperature range.

In any of the embodiments of the disclosure, the direct reduced iron is flowed from the reduction zone into the cooling zone. Cooling hydrogen can be flowed into the cooling zone to cool the direct reduced iron by heat exchange. The cooling hydrogen can enter the cooling zone at a temperature of about >0° C. (to avoid freezing of potential remaining water in the recirculated H₂ gas) to about 300° C. The cooling hydrogen flows in a direction counter to the flow of the direct reduced iron, such that after heat exchange with the direct reduced iron, the hydrogen flows into the reduction zone. The cooling hydrogen can be heated by heat exchange with the hot direct reduced iron to between 500° C. and 900° C. and flows into the reduction zone, and mixes with the hydrogen introduced into the reduction zone to participate in direct reduction of the iron and/or combustion with oxygen (if present) in the reduction zone.

In any of the embodiments of the disclosure, the hydrogen flows in a counter direction to the flow of the iron, rising from the cooling zone and the reduction zone inlets and through the furnace to the heating zone to eventually leave the furnace as a top gas. The hydrogen rising from the cooling and/or reduction zone into the heating can retain a sufficient amount of heat to heat the iron ore in the heating zone by heat exchange. In embodiments including a heat carrier gas, the heat carrier gas also flows counter to the direction of flow of the iron ore and leaves the furnace as part of the top gas. The heat carrier gas can similarly participate in thermal exchange in the heating zone to heat the iron ore before exiting with the top gas.

The residence time of the iron ore in the heating zone can be a time sufficient for the iron ore to achieve a target temperature. The residence time can depend, for example, on the heat capacity of ores and heat transfer between the heating source and ore stream, which are in turn affected by reactor design, the heating means (e.g. electric heating) and the energy input into the heating zone to raise the temperature. For example, where heat exchange with top gas is used, the residence time can be sufficient for heat to exchange from the top gas into the iron ore. For example, the residence time can be about 1 hour to about 4 hours.

The residence time of the iron ore in the reduction zone can be a time sufficient to achieve a target metallization of the iron in the iron ore. The residence time can depend, for example, on the reactor design, pellet/particle size of iron ores, hydrogen preheating temperature and temperature within the shaft furnace at the reduction zone and other factors. The residence time of the iron ore in the reduction zone can be, for example, about 2 hours to about 10 hours.

The residence time of the iron in the cooling zone can depend on the desired temperature to which the iron is to be cooled and/or the temperature of the cooling hydrogen. For example, the residence time in the cooling zone can be about 1 hour to about 4 hours.

The hydrogen counterflow, originating from both the cooling zone and the reduction zone, can ultimately exit the shaft furnace through an outlet located upstream of the heating zone. This hydrogen exits the shaft furnace as “top gas.” In some embodiments, the top gas can be collected and processed to recover hydrogen for recycling into the direct reduction process. For example, after leaving the shaft furnace, the top gas can be cleaned and condensed to remove dust, impurities, and water vapor, leaving a gas stream primarily composed of hydrogen. The recovered hydrogen can then be recompressed and optionally combined with make-up hydrogen before being recirculated into the system as bustle gas. In embodiments where hydrogen is preheated before entering the shaft furnace, the recycled hydrogen and make-up hydrogen (additional hydrogen supplied as needed) can be combined, optionally preheated, and then introduced into the shaft furnace through the bustle gas inlet. Although excess hydrogen flows through the process—resulting in increased compressor size, compression energy use, and preheating requirements—the net hydrogen consumption is minimized because it is primarily used for the reduction reaction. Similarly, in embodiments where a heat carrier gas is used, this inert carrier gas exits along with unreacted hydrogen as part of the top gas. The heat carrier gas can also be preheated and recycled back into the shaft furnace. Thus, this method conserves both hydrogen and heat carrier gas. In any of the methods of the disclosure in which oxygen is flowed into the shaft furnace, the oxygen can be flowed into the furnace at a rate of about 5 Nm³/MT DRI to about 100 Nm³/MT DRI.

In methods of the disclosure using oxygen combustion within the shaft furnace and/or electrically heating the shaft furnace, the hydrogen can be flowed into the shaft furnace such that the molar ratio of H₂:Fe₂O₃ within the reduction zone is equal to or greater than the minimum hydrogen demand needed for reduction. For example, the hydrogen can be flowed into the shaft furnace in such embodiments such that a molar ratio of H₂:Fe₂O₃ is about 6 mol/mol mol/mol (minimum hydrogen demand) to about 15 mol/mol.

In any of the methods of the disclosure, the method can be free of mixing hydrogen with oxygen outside of the shaft furnace and/or combustion of hydrogen with oxygen before hydrogen is introduced into the shaft furnace.

In any of the methods of the disclosure, the bustle gas can be preheated before flowing the bustle gas into the shaft furnace. Preheating can be accomplished by electrical methods and without combustion of the hydrogen outside of the shaft furnace. For example, electrical heating can be by one or more of Joule heating, plasma heating, and microwave heating. Any known electrical heating methods and equipment that are compatible with H₂ can be used. Preheating can also be accomplished by heat exchange using a heat transfer medium, such as steam or molten salt. Preheating can be accomplished through a single stage or multistage process. For example, a combination of heat exchange and electric heating can be used in a multistage heating process. In addition to electric heating, the bustle gas can also be preheated by thermal energy in one or more of the heating stages, for example, using heat from nuclear reactor thermal output, heat pump, heat pipe and heat exchanger; or using waste heat from other plants, heat provided by combustion of fuels (e.g. waste fuels, biomass), etc.

In any of the methods of the disclosure, the bustle gas can be flowed into the shaft furnace through the bustle gas inlet and have a moisture content of about 0% to about 10%. Higher than 10% moisture content can hamper iron reduction extent or conversion.

In any of the methods of the disclosure, the iron ore can include one or more of hematite, magnetite, and wustite. The iron ore can have an iron content, for example, 66% or higher. Lower iron content might increase energy consumption and impact the further processing (e.g. DRI iron processing to steel in electric arc furnace).

In any of the methods of the disclosure, the method can further include flowing the direct reduced iron from the cooling zone of the shaft furnace to an electric arc furnace or other process for refining the direct reduced iron into steel.

### Systems of the Disclosure

In each of the systems of the disclosure, the system includes a shaft furnace having a heating zone, a reduction zone, and a cooling zone. Iron ore is adapted to be loaded into the shaft furnace through the heating zone. Each system further includes a bustle gas source from which bustle gas comprising hydrogen can be flowed into the shaft furnace through a bustle gas inlet. Each system also includes a cooling hydrogen gas source, with cooling hydrogen being adapted to be flowed into the shaft furnace through a cooling hydrogen gas inlet arranged in the cooling zone. The cooling hydrogen gas source can be, for example, a combination of the bustle gas source with a cooling unit. In such embodiments, a single bustle gas source can be used for supplying hydrogen to both the bustle gas inlet and the cooling hydrogen gas inlet.

Referring to FIG. 1A, systems in accordance with the disclosure can additionally include an oxygen source. Bustle gas from the bustle gas source can be flowed into the shaft furnace through a bustle gas inlet disposed at a downstream end of the reduction zone in the shaft furnace. Oxygen from the oxygen source can be flowed into the shaft furnace through an oxygen inlet disposed upstream of the bustle gas inlet. The system can optionally include a bustle gas preheating unit arranged between the bustle gas source and the bustle gas inlet to preheat the hydrogen before it is flowed into the shaft furnace through the bustle gas inlet. The bustle gas preheating unit can include one or more stages for heating using any known heating equipment and methods, such as electrical heating, thermal heat, or heat exchanger. For example, the preheating unit can be adapted to heat the hydrogen by heat exchange or by thermal heating. For example, the preheating unit can include electrical heaters, such as, but not limited to, Joule heaters, resistive heaters, and microwave heaters.

Referring to FIG. 1B, systems in accordance with the disclosure can further include a bustle gas preheating unit arranged between the bustle gas source and the bustle gas inlet to preheat the bustle gas before it is flowed into the shaft furnace through the bustle gas inlet. The preheating unit can include one or more stages for heating using any known heating equipment and methods, such as electrical heating, thermal heating, or heat exchange. For example, the bustle gas preheating unit can be adapted to heat the bustle gas by heat exchange or by thermal heating. For example, the bustle gas preheating unit can include electrical heaters, such as, but not limited to, Joule heaters, resistive heaters, and microwave heaters. Such systems can be adapted to preheat the bustle gas without combustion of the hydrogen outside of the shaft furnace as well as inside the shaft furnace. The systems can be adapted to flow preheated bustle gas at a temperature of about 600° C. to about 1100° C. into the shaft furnace through the bustle gas inlet in an amount greater than a minimal amount needed for reduction of the iron. For example, the system can be adapted to flow the preheated bustle gas into the shaft furnace such that an amount of hydrogen present in the reduction zone is about 1.25 to 2 times the minimum hydrogen demand. For example, the system can be adapted to flow bustle gas into the shaft furnace such that a molar ratio of H₂:Fe₂O₃ within the reduction zone is 7 to 15 mol/mol. Alternatively, the system can include an inert gas source and a preheating unit, which can be the same or different than the preheating unit for bustle gas, to flow heated inert gas into the shat furnace to supply heat as described above. The preheating unit for the inert gas, if different than the preheating unit for the bustle gas, can use any known heating equipment and methods, including but not limited to, electrical heating, thermal heating, or heat exchange. In such alternatives, hydrogen can be supplied at the minimum hydrogen demand amount or greater. For example, the bustle gas can be flowed into the reduction zone such that a molar ratio of H₂:Fe₂O₃ within the reduction zone is 6 to 10 mol/mol, and a molar ratio of heat carrier gas:Fe₂O₃ within the reduction zone is 4 to 9 mol/mol when the heat carrier gas is nitrogen for example. Selection of the number of mols of heat carrier gas needed to deliver sensible heat to the system can depend, at least in part, on the heat capacity of the inert gas used. The system can include an inlet for the inert gas that is separated from the bustle gas inlet. Alternatively, the inert gas can be mixed with the bustle gas before or after preheating but before being flowed into the shaft furnace. In embodiments of such systems, the systems can be free of an oxygen source and flowing of oxygen into contact with hydrogen for combustion.

Referring to FIG. 1C, the system can further include an electrical heating unit arranged to heat at least the reduction zone of the shaft furnace. For example, electrical heating unit can include one or more heating elements attached to, integral with, and/or embedded within one or more internal walls of the shaft furnace. Any known electrical heating elements or means can be used. For example, the electrical heating can be accomplished by one or more resistive heating elements disposed on and/or embedded within the walls of the shaft furnace. For example, the electrical heating can be accomplished by an induction coil heater wrapped around the shaft furnace.

As described with respect to the methods of the disclosure, the systems of the disclosure can include any combination of heating means for maintaining a temperature for reduction within the reduction zone of the shaft furnace. The selection of heating means can be made for tailoring a desired consumption of hydrogen, oxygen, thermal energy and electricity, and/or considering accessibility to economic energy source (e.g. electricity or thermal energy). For example, reduced oxygen and/or hydrogen consumption can be achieved by incorporating additional heating of the bustle gas in a preheating unit and/or by incorporating electrical heating elements in the shaft furnace. For example, reduced hydrogen consumption can be achieved in a system by preheating bustle gas and flowing in an amount such that hydrogen is flowed into the shaft furnace is in excess of the minimum demand or the bustle gas comprises or is flowed in combination with a preheated heat carrier (inert) gas, to thereby carry out sufficient heat while avoiding H₂ combustion such as shown in FIG. 1B or by incorporating a plasma heating unit such as shown in FIG. 1D to achieve high temperature hydrogen for input into the shaft furnace.

Each of the systems in accordance with the disclosure further includes a cooling hydrogen gas source. In some embodiments, the cooling hydrogen gas unit includes a cooling unit that cools hydrogen supplied from the bustle gas source. The bustle gas source can be both the supply of the cooling hydrogen and the hydrogen for flow into the bustle gas inlet. Alternatively, a separate cooling hydrogen gas source can be provided in the systems separate from the bustle gas source for flowing hydrogen into the shaft furnace.

Systems of the disclosure can further include a top gas recovery unit. The top gas recovery unit can include a condenser for condensing the top gas recovered from the shaft furnace to condense water vapor present therein and separate hydrogen. The top gas recovery unit can further include one or more auxiliary units, such as de-dusting or other cleaning units to remove impurities from the top gas and/or recovered hydrogen. For example, when a heat carrier gas is used, one or more auxiliary units can include a unit for separation of the inert gas from the hydrogen. The system can include fluid communication of the top gas recovery unit or auxiliary unit with the bustle gas inlet or bustle gas preheating unit, when present, to allow for recycling of the hydrogen back into the system. Hydrogen from the top gas recovery unit can be mixed with bustle gas source when needed to maintain a sufficient amount of hydrogen needed in the system. The system can include fluid communication of the top gas recovery unit or auxiliary unit with the heat carrier gas inlet (when present) or mixing unit for mixing the bustle gas and heat carrier gas, or a preheating unit to allow for recycling of the hydrogen back into the system.

### EXAMPLES

Systems and methods in accordance with the disclosure as shown in FIGS. 1A-1C were modeled to examine the hydrogen, oxygen, and electrical consumption.

### DRI Modeling Methodology

In the modeled case, a DR shaft furnace using hydrogen as a reductant is modeled. The shaft furnace was designed based on an industrial furnace for DRI technology with syngas, using an inner diameter of the furnace of 6.5 m. The size of the reduction zone was estimated based on the residence time of the burden and the annual production capacity. The iron ore burden typically spends a number of hours, e.g. 2-10, preferrable 4-8 hours in the reduction zone. Iron ore entered the shaft furnace from the top through a feed hopper. The iron ore feed was pre-heated up to a temperature of 600° C. by the hot gas leaving the reduction zone. As the iron ore descended, it was reduced by the counter-current flow of hydrogen fed from the bottom of the shaft furnace, eventually reaching a high metallization rate of 95%. The metal iron was then cooled in the cooling zone and discharged from the furnace. Hydrogen was mainly fed through ports on the wall at the bottom of the reduction zone. A portion of hydrogen was used as a cooling gas from the bottom of the furnace to cool the DRI and entered the reduction zone after the heat exchange. Oxygen was injected near the top of the furnace to provide additional heat through combustion inside the furnace. The schematic diagram of the system is shown in FIG. 1A.

To analyze the conversion profile and energy demand along the axial direction, the reduction zone was simulated using kinetics from the REDUCTOR model [1], which was developed based on plant operation data for DRI shaft furnaces using both CO and H₂. The REDUCTOR model accounts for heat and mass transfer, including intra-particle and inter-particle diffusion. Detailed reactor modeling can be found in the original work by Hamadeh [2]. Although originally designed for 2D axisymmetric simulations, the REDUCTOR model was modified using 1D Navier-Stokes equations, which were sufficient for estimating conversions at different axial positions in the reactor. These equations were solved numerically using the finite volume method. Thermodynamic property data for iron oxide reduction was sourced from established references [3] [4]. Using the conversion results from reactor modeling, the hydrogen-based DRI production process was then simulated in Aspen Plus to determine overall energy and material balances, including preheating, cooling, separation, and other auxiliary units. The energy consumption for each simulated scenario is listed in Table 5.

In addition to the shaft furnace, the Aspen Plus model included other components in the DRI process. Heaters were used to preheat the hydrogen and oxygen feed to elevated temperature, e.g. 950° C., before entering the furnace. A water scrubber was used to remove dust and condense steam from the top gas before the reductant was recycled. The shaft furnace was split into three different zones:

Heating zone, where the iron ore is heated by the top gas leaving the reduction zone.

Reduction zone, where the iron ore reduction takes place.

Cooling zone, where the iron ore is cooled down before discharging from the furnace.

The heating zone and cooling zone were modeled as simple heat exchangers. The heat transfer coefficient was calculated using the Gunn relation [5], which describes heat transfer between fluid and particulate phases. The top gas left the furnace from the top outlet at 350-400° C. A series of conversion reactors were used to represent the different sections of the reduction zone. The conversion of each reactor is calculated offline using reactor modeling. The hematite ore goes through two intermediate oxidation states, namely magnetite and wüstite before finally being reduced to metallic iron. The reduction of iron ore by hydrogen is done through the following reactions:

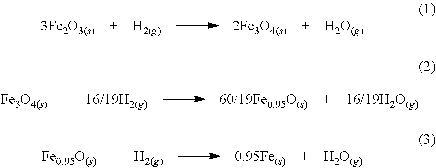

### Reactor Simulation Results

Using the methodology described earlier, the percentage of reduced iron, known as metallization degree along the DRI shaft furnace reduction zone was estimated by solving physics-based models of heat balance, mass balance, and reaction kinetics. A reduction zone of DRI furnace was modeled, considering the case of a diameter of 6.5 m and a height of 18.5 m. The burden is assumed to reside around 6 hours in the reduction zone. The estimated production capacity of the shaft furnace is 2 MMT DRI per year (325 operating days).

### Example 1

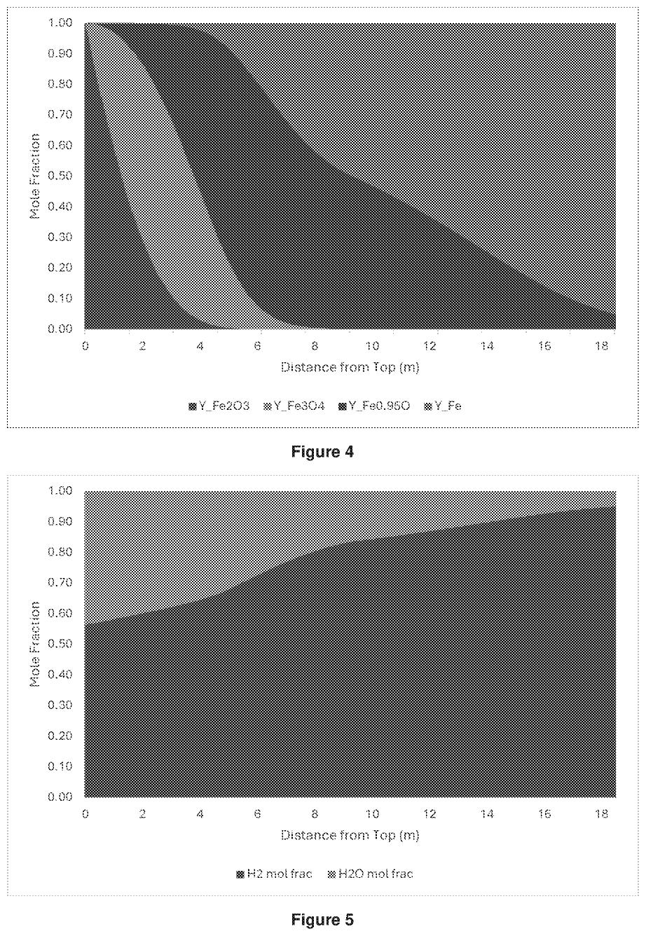

The reduction zone was first simulated with feeding a minimum demand of hydrogen and the metallization rate was 54%, because a rapid temperature drop leading to decreased reaction rates (shown in Table 1). The temperature profiles of the reduction zone are shown in FIG. 3. The composition of the solid and gas phases was plotted in FIGS. 4 and 5.

TABLE 1
Mass and heat balance based on reactor kinetics at stoichiometric feed,

| | | | | | Temper- |
|---|---|---|---|---|---|
| | Hydrogen | | Water | Flowrate | ature |
| Gas | (mol %) | | (mol %) | (mol/s) | (° C.) |
| Input | 0.95 | | 0.05 | 4856 | 950 |
| Output | 0.66 | | 0.34 | 4856 | 535 |
| | | | | | Temper- |
| | Hematite | Wüstite | | Flowrate | ature |
| Solid | (mol %) | (mol %) | Iron(mol%) | (mol Fe/s) | (° C.) |
| Input | 1 | 0 | 0 | 1243 | 535 |
| Output | 0 | 0.66 | 0.34 | 1243 | 950 |

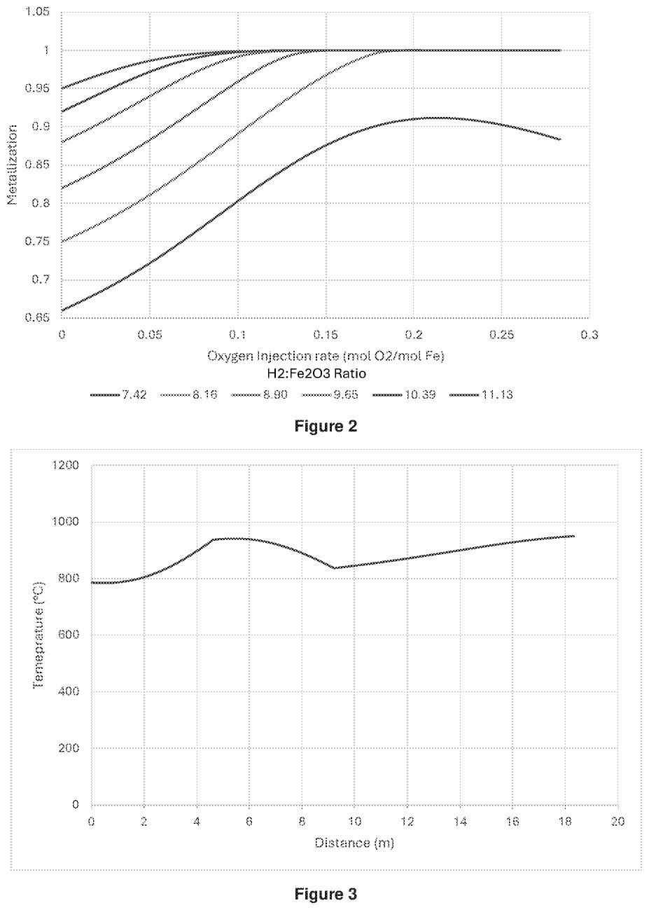

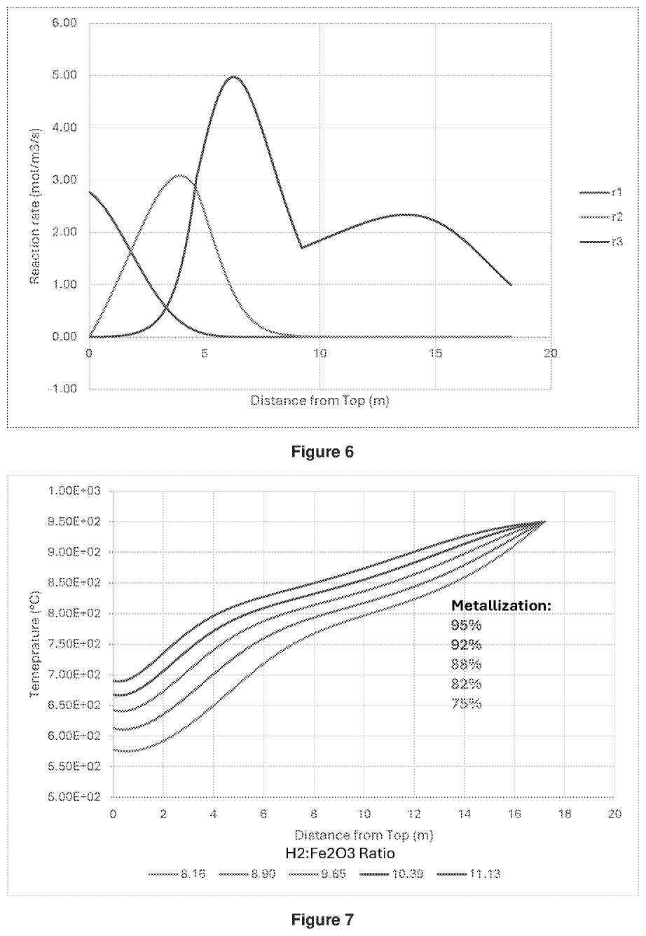

To achieve the target conversion of 95%, additional heat was required to accelerate the reaction rate. Using the previously described methods, heat was introduced through various means. The target metallization was set at 95%. In the first example, oxygen was injected into the furnace. To compensate for hydrogen consumption due to oxygen injection, the hydrogen flow rate was increased. Since hydrogen combusts rapidly with oxygen, this injection provided concentrated heat efficiently. Oxygen was introduced at multiple points near the top of the furnace, where temperatures were lower, to prevent overheating. The heat generated from combustion was carried downstream, necessitating sufficient reactor volume for effective oxygen injection. In the simulation, oxygen was injected between 1 m and 9 m from the top of the furnace. The impact of oxygen injection rate was analyzed. At low injection rates, oxygen addition almost linearly increased the metallization, as shown in FIG. 2. However, increasing oxygen led to diminishing returns due to excessive moisture affecting reactor equilibrium. Modeling results indicated that the maximum effective oxygen injection rate was 104 mol/s, or 31.5 Nm³/MT for the modeled case. The temperature, metallization, mole fraction and reaction rate profiles are shown in FIGS. 3-6, while the mass balance data is presented in Table 2. In practice, the maximum allowable oxygen injection is constrained by furnace temperature limits, as excessive heat can cause iron ore particle clustering. While oxygen injection alone may not supply all the necessary heat for reaction, it significantly enhances the process conversion while keeping the hydrogen flow close to minimum.

TABLE 2
Mass and Heat Balance on Reactor Kinetics with Oxygen Injection

| | | | | | Temper- |
|---|---|---|---|---|---|
| | | | | Flowrate | ature |
| Gas | Hydrogen | Oxygen | Water | (mol/s) | (° C.) |
| Input | 0.95 | 0 | 0.05 | 5176 | 950 |
| Injection | 0 | 1 | 0 | 100 | 950 |
| Output | 0.56 | 0 | 0.44 | 5176 | 786 |
| | | | | | Temper- |
| | | | | Flowrate | ature |
| Solid | Hematite | Wüstite | Iron | (mol Fe/s) | (° C.) |
| Input | 1 | 0 | 0 | 1243 | 785 |
| Output | 0 | 0.05 | 0.95 | 1243 | 950 |

The simulation was also run to analyze different oxygen injection rates and different hydrogen flow rates. Referring to FIG. 2, the results illustrate that oxygen injection alone was not sufficient to reach desired metallization and increased hydrogen flow rate was needed. Excess oxygen injection can lead to lower metallization.

### Example 2

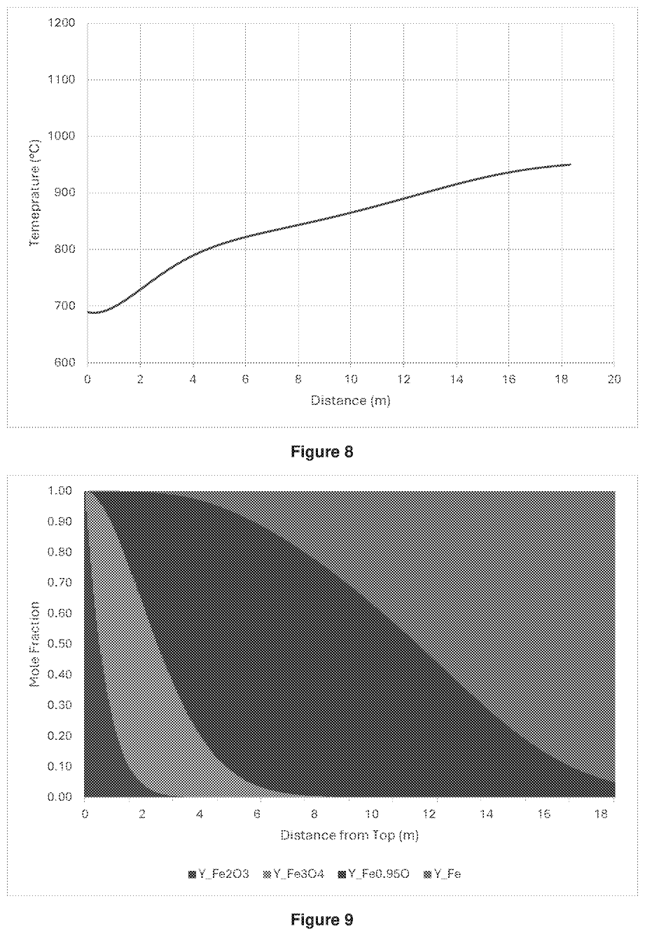

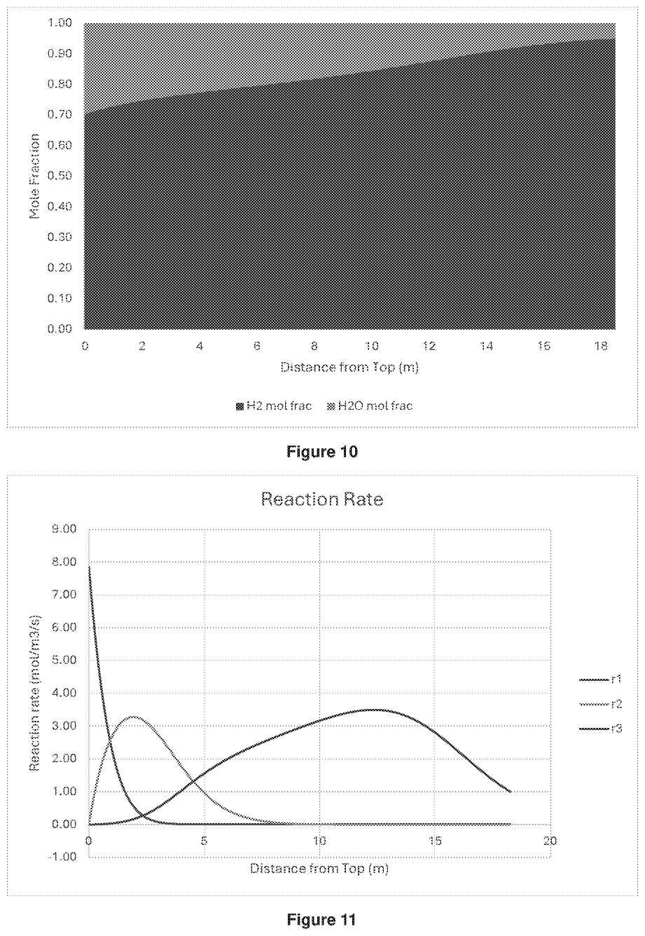

In the second example, additional preheated H₂ was introduced as a heat carrier beyond the minimum required demand. Various H₂ flow rates, expressed as ratios relative to the minimum hydrogen demand, were analyzed in the model. At H₂:Fe=11.1, equivalent to 1.5 times the minimum hydrogen demand, the furnace was sufficient to achieve 95% metallization. The temperature profiles and the relationship between metallization and hydrogen feed rate is shown in FIG. 7. The temperature, metallization, and mole fraction and reaction rate profiles are presented in FIGS. 8-11, while the mass balance data is summarized in Table 3. The 1.5× minimum case demonstrated sufficient improvement to reach the target metallization of 95%.

TABLE 3
Mass and heat balance of Example 2 with excess flow

| | | | | | Temper- |
|---|---|---|---|---|---|
| | | | | Flowrate | ature |
| Gas | Hydrogen | Oxygen | Water | (mol/s) | (° C.) |
| Input | 0.95 | 0 | 0.05 | 7257 | 950 |
| Output | 0.70 | 0 | 0.30 | 7257 | 690 |
| | | | | | Temper- |
| | | | | Flowrate | ature |
| Solid | Hematite | Wüstite | Iron | (mol Fe/s) | (° C.) |
| Input | 1 | 0 | 0 | 1243 | 690 |
| Output | 0 | 0.0 | 0.95 | 1243 | 950 |

The temperature profiles for different hydrogen-to-iron-oxide ratios was also analyzed. Referring to FIG. 7, hydrogen-to-iron-oxide ratios of 8.16, 8.90, 9.65, 10.39, 11.13 were analyzed. The results illustrate that temperature increased as hydrogen flow rate increased, which in turn drove up the iron ore reduction reactions, leading to higher metallization rates. The ratio of hydrogen-to-iron-oxide of 11.13 achieved a metallization rate of 95%, whereas the ratio of 10.39 achieved a metallization rate of 92%, ratio of 9.65 achieved a metallization rate of 88%, ratio of 8.90 achieved a metallization rate of 82%, and 8.16 achieved a metallization rate of 75%.

### Example 3

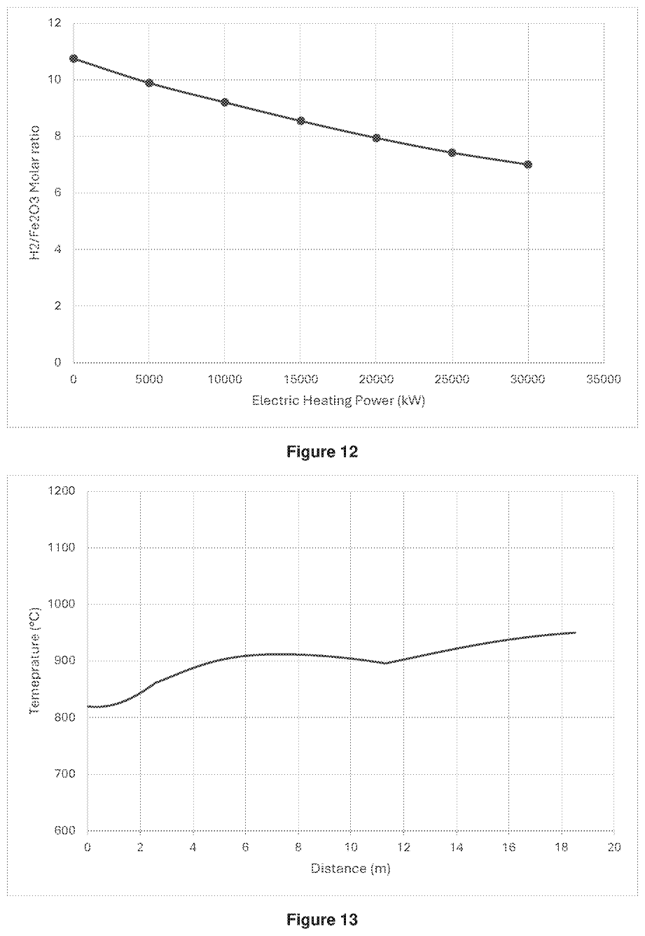

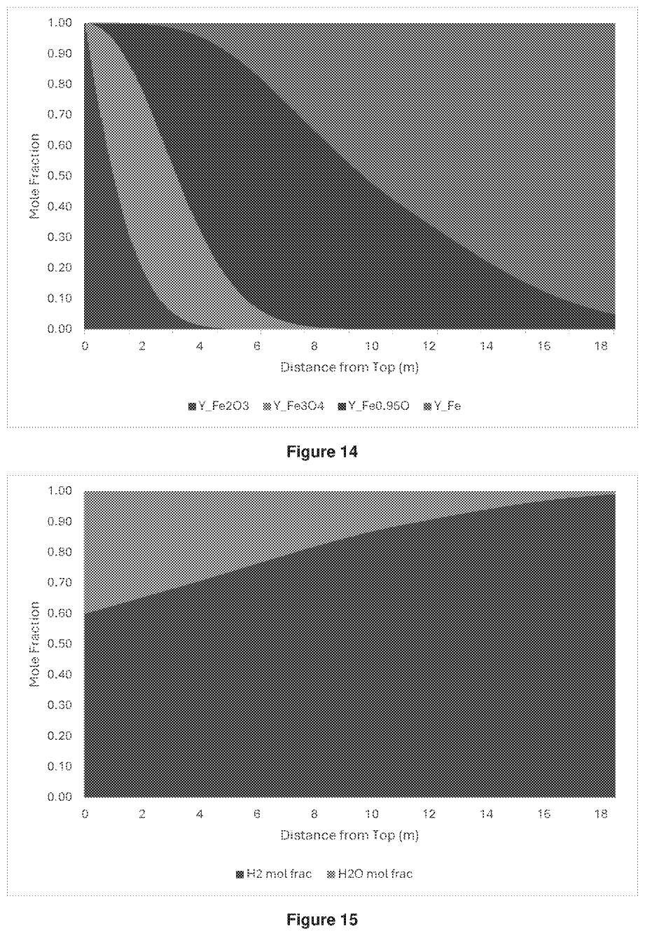

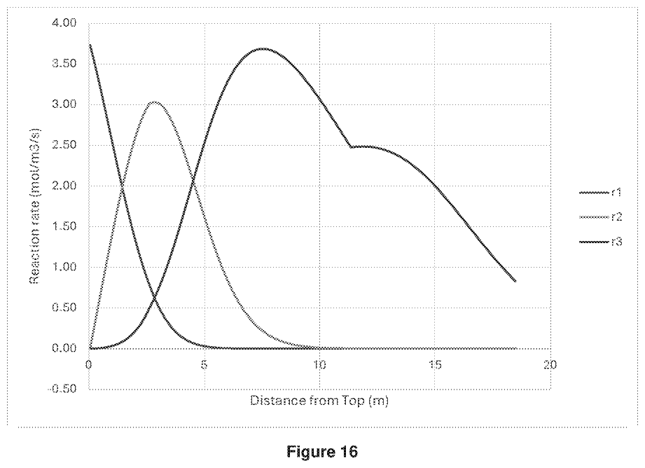

In the third example, heat was supplied directly to the reactor through electrical heating. This method allowed precise temperature control without introducing additional reactants. In the simulation, resistive heating is installed between 2 m and 11 m from the top of the furnace. Various power input levels were analyzed to determine their effect on metallization. The results showed that a sufficient power input could achieve 95% metallization without significantly altering the gas composition. The relationship between the necessary hydrogen flow rate to achieve 95% metallization and power input is shown in FIG. 12. The temperature, metallization, mole fraction and reaction rate profiles are presented in FIGS. 13-16, while the mass balance data is summarized in Table 4. The total required power is 25 MW which is a significant amount. Temperature uniformity in the radial direction can be a concern since electrical heaters can only be installed along the furnace's circumference. Although the practical limit for electrical heating is unknown and depends on the specific design of a furnace, the analysis indicated that direct electrical heating provided an effective means of supplying the necessary heat to drive the reaction while maintaining process stability.

TABLE 4
Mass and heat balance of Example 3 with electrical heating

| | | | | | Temper- |
|---|---|---|---|---|---|
| | | | | Flowrate | ature |
| Gas | Hydrogen | Oxygen | Water | (mol/s) | (° C.) |
| Input | 0.95 | 0 | 0.05 | 5497 | 950 |
| Output | 0.62 | 0 | 0.38 | 5497 | 820 |
| | | | | | Temper- |
| | | | | Flowrate | ature |
| Solid | Hematite | Wüstite | Iron | (mol Fe/s) | (° C.) |
| Input | 1 | 0 | 0 | 1243 | 820 |
| Output | 0 | 0.05 | 0.95 | 1243 | 950 |

### Example 4

### Aspen Plus Modeling Results

Based on the results obtained from the reactor simulation, a process model was built in Aspen Plus. The incoming hydrogen and oxygen feed into the shaft furnace are preheated in a two-stage heater that heats the gas up to 950° C. The reduction zone was represented by three reactors. For each reactor, the conversion value was calculated from computed results from the reactor simulation. The energy and mass balance from Aspen Plus was compared with the reactor simulation and showed consistency.

In the process simulation, top gas is cleaned, cooled to remove water, recompressed and mixed into the feed stream. The process simulation gives the overall material and energy consumption including hydrogen, heating, compression energy and cooling duty. Various losses such as heat loss, incomplete combustion, gas leaks are also accounted for in the process simulation. The overall energy consumption is shown in the table below and compared to a reference design [6], where the top gas is partially combusted to fuel the heating of bustle gas, much like the incumbent natural-gas based DRI. The final energy and material consumption for the overall DRI process were tabulated in Table 5.

TABLE 5
Material and energy consumption data of reference case and examples

| | | Method of | | |
|---|---|---|---|---|
| | Reference | FIG. 1A | | |
| | design | (with 11 Nm³ | Method of | Method of |
| | ⁱ(combusting | O₂/MT | FIG. 1B | FIG. 1C |
| | top gas to | injection | (with excess | (with in-situ |
| | preheat | upstream of | hydrogen as | electrical |
| | hydrogen) | hydrogen) | heat carrier) | heating) |
| | flow | flow | flow | flow |
| Case | ratio = 10.75 | ratio = 8.92 | ratio = 10.75 | ratio = 8.60 |
| Net Fuel | mol H₂/mol | mol H₂/mol | mol H₂/mol | mol H₂/mol |
| Consumption | Fe₂O₃ | Fe₂O₃ | Fe₂O₃ | Fe²O³ |
| Total hydrogen | 189.5 | 132.5 | 189.5 | 130.8 |
| Flow rate (kg/MT | | | | |
| DRI) | | | | |
| Hydrogen | 110.2 | 76.5 | 135.5 | 76.8 |
| recirculation | | | | |
| Net Hydrogen | 79.3 | 56.0 | 54.0 | 54.0 |
| consumption/ | | | | |
| make up | | | | |
| Hydrogen as fuel | 25.3 | 2.0 | 0 | 0 |
| (kg/MT DRI) | | | | |
| Oxygen (kg | 200.4 | 15.8 | 0 | 0 |
| O2/MT DRI) | | | | |
| Energy for | — | 400.5 | 579.4 | 388.4 |
| Heating | | | | |
| (kWh/MT DRI) | | | | |
| Electricity for | 56.4 | 39.1 | 69.3 | 39.3 |
| Compression | | | | |
| (kWh/MT DRI) | | | | |
| Total Energy | 11309 | 9529 | 9998 | 9202 |
| Usage (MJ/MT | | | | |
| DRI) | | | | |

Two shaft furnace design configurations were also modelled and analyzed. The feedstock and energy consumption data is shown in Table 6 below. Case 1 used only hydrogen as a reductant as the heat carrier. Case 2 used oxygen injection with hydrogen as fuel to provide heat internally. Case 2 used more hydrogen but less electricity, steam, process water, and cooling water.

TABLE 6

| Feedstock/energy | Case 1 per MT DRI | Case 2 per MT DRI |
|---|---|---|
| Iron ore pellets | 1,405 kg | 1,405 kg |
| Electricity (heating) | 520 kWh | 425 kWh |
| Electricity (compression) | 69 kWh | 52 kWh |
| Auxiliary electricity | 109 kWh | 109 kWh |
| Hydrogen | 52.9 kg | 54.8 kg |
| H—Fe ratio | | |
| Steam @250° C. | 135.8 kg | 121.4 kg |
| Oxygen | N/A | 14.3 kg |
| Cooling water | 33.0 m³ | 30.3 m³ |
| Process water | 2.64 m³ | 2.43 m³ |

### Aspects

Aspect 1. A method for producing direct reduced iron (DRI) using a shaft furnace comprising a heating zone, a reduction zone, and a cooling zone, the method comprising:
loading iron ore into a furnace at the heating zone, wherein the iron ore is heated to a target temperature;
flowing a bustle gas comprising hydrogen gas into the furnace through a bustle gas inlet disposed at a downstream end of the reduction zone;
flowing oxygen and/or an oxygen enriched gas into the shaft furnace through an oxygen inlet disposed upstream of the bustle gas inlet, wherein a portion of the hydrogen combusts with the oxygen within the shaft furnace and releases heat internally within the shaft furnace;
flowing the iron ore from the heating zone into the reduction zone, wherein the iron ore is reduced to iron through reaction of the iron ore with the hydrogen, thereby producing direct reduced iron (DRI);
flowing a cooling hydrogen gas into the cooling zone; and
flowing the direct reduced iron (DRI) from the reduction zone into the cooling zone to cool the direct reduced iron by heat exchange with the cooling hydrogen gas, wherein the cooling hydrogen gas, after heat exchange with the direct reduced iron (DRI) flows into the reduction zone,
wherein hydrogen and formed steam present in the shaft furnace from the bustle gas and/or cooling gas flows from the cooling and/or reduction zones upstream into the heating zone to heat the iron ore through heat exchange before exiting as a top gas.
Aspect 2. The method of aspect 1, wherein the bustle gas is preheated to a temperature of about 500° C. to about 1100° C. by a single stage or multi-stage heating process before flowing into the shaft furnace.
Aspect 3. The method of aspect 1 or 2, wherein the oxygen is flowed into the furnace at a rate of about 5 Nm³/MT DRI to about 100 Nm³/MT DRI.
Aspect 4. The method of any one of aspects 1 to 3, wherein bustle gas is flowed into the furnace such that H₂ is flowed into the reduction zone to achieve a ratio of H₂:Fe₂O₃ is about 6 to about 15 mol/mol within the reduction zone.
Aspect 5. The method of any one of aspects 1 to 4, further comprising electrically heating the shaft furnace in at least the reduction zone.
Aspect 6. The method of aspect 5, wherein electrically heating the shaft furnace comprises one or more resistive heating elements disposed on and/or embedded within the walls of the shaft furnace at least in the reduction zone.
Aspect 7. The method of aspect 5 or 6, wherein electrically heating the shaft furnace comprises heating through induction coils wrapped around the furnace in the at least the reduction zone.
Aspect 8. A method for producing direct reduced iron (DRI) using a shaft furnace comprising a heating zone, a reduction zone, and a cooling zone, the method comprising:
loading iron ore into a furnace at the heating zone, wherein the iron ore is heated to a target temperature;
flowing a bustle gas comprising hydrogen into the shaft furnace at a downstream end of the reduction zone, wherein the bustle gas is preheated without combustion of the hydrogen to a temperature of about 650° C. to about 1100° C. before being flowed into the shaft furnace, and flows within the shaft furnace through the reduction zone and into the heating zone; optionally flowing a heat carrier gas into the shaft furnace at the downstream end of the reduction zone, wherein the heat carrier gas comprises an inert gas and is preheated to a temperature of about 650° C. to about 1100° C. before being flowed into the shaft furnace;
flowing the iron ore from the heating zone into the reduction zone, wherein the iron ore is reduced to iron through reaction of the iron ore with the preheated bustle gas, thereby producing direct reduced iron (DRI);
flowing a cooling hydrogen gas into the cooling zone; and
flowing the direct reduced iron (DRI) from the reduction zone into the cooling zone to cool the direct reduced iron by heat exchange with the cooling hydrogen gas, wherein the cooling hydrogen gas, after heat exchange with the direct reduced iron (DRI) flows into the reduction zone,
wherein:
a molar ratio of H₂:Fe₂O₃ of about 7.4 mol/mol is a minimum hydrogen demand for a target 95% metallization of iron from the iron ore at 950° C.,
when the heat carrier gas is not present, the preheated bustle gas is flowed into the shaft furnace such that an amount of hydrogen within the reduction zone is greater than the minimum hydrogen demand,
when the heat carrier gas is present, the bustle gas is flowed into the shaft furnace such that an amount of hydrogen within the reduction zone is equal to or greater than the minimum hydrogen demand,
and
wherein hydrogen present in the shaft furnace flows from the cooling and/or reduction zones upstream into the heating zone to heat the iron ore through heat exchange before exiting as a top gas, and optionally, when present, the heat carrier gas flows from the reduction zone upstream into the heating zone to heat the iron ore through heat exchange before exiting with the top gas.
Aspect 9. The method of aspect 8, wherein the heat carrier gas is present and is premixed with the bustle gas before being flowed into the shaft furnace.
Aspect 10. The method of aspect 8, wherein the heat carrier gas is present and the heat carrier gas is flowed into the shaft furnace through a heat carrier gas inlet.
Aspect 11. The method of any one of aspects 9 or 10, comprising flowing the bustle gas into the shaft furnace such that the amount of hydrogen within the reduction zone is equal to the minimum hydrogen demand.
Aspect 12. The method of aspect 11, wherein the inert gas is N₂ and the method comprising flowing heat carrier gas into the reduction zone such that a molar ratio of inert gas:Fe₂O₃ is 4 mol/mol to 9 mol/mol.
Aspect 13. The method of aspect 9 or 10, comprising flowing the bustle gas into the shaft furnace such that the amount hydrogen within the reduction zone is greater than the minimum hydrogen demand.
Aspect 14. The method of aspect 13, comprising flowing the bustle gas into the shaft furnace such that a molar ratio of H₂:Fe₂O₃ within the reduction zone is greater than 6 mol/mol to 15 mol/mol; and flowing the heat carrier gas into the shaft furnace such that a molar ratio of inert gas:Fe₂O₃ is 2 mol/mol to 9 mol/mol.
Aspect 15. The method of aspect 8, wherein when no heat carrier gas is present, the preheated bustle gas is flowed into the shaft furnace such that a molar ratio of H₂:Fe₂O₃ is 7 mol/mol to 15 mol/mol.
Aspect 16. The method of any one of aspects 8 to 15, comprising preheating the bustle gas and the heat carrier gas, when present, by one or more stages of electric heating and/or thermal heating.
Aspect 17. The method of aspect 16, wherein the electric heating comprises one or more of Joule heating, plasma heating, and microwave heating, and/or wherein the thermal heating comprises nuclear reactor thermal output, heat pump, or waste heat from other sources.
Aspect 18. The method of any one of aspects 8 to 17, wherein the method is free of additional heating of the shaft furnace from a source other than the preheated bustle gas and, when present, the heat carrier gas.
Aspect 19. The method of any one of aspects 8 to 18, wherein the method is free from flowing oxygen into the shaft furnace.
Aspect 20. The method of any one of aspects 8 to 17, further comprising electrically heating the shaft furnace in at least the reduction zone.
Aspect 21. The method of aspect 20, wherein electrically heating the shaft furnace comprises one or more resistive heating elements disposed on and/or embedded within the walls of the shaft furnace at least in the reduction zone.
Aspect 22. The method of aspect 20 or 21, wherein electrically heating the shaft furnace comprises heating through induction coils wrapped around the furnace in the at least the reduction zone.
Aspect 23. The method of any one of aspects 8 to 17, further comprising flowing oxygen and/or an oxygen enriched gas into the shaft furnace through an oxygen inlet disposed upstream of the bustle gas inlet, wherein hydrogen combusts with the oxygen within the shaft furnace and releases heat internally within the shaft furnace.
Aspect 24. The method of aspect 23, further comprising electrically heating the shaft furnace in at least the reduction zone.
Aspect 25. The method of aspect 24, wherein electrically heating the shaft furnace comprises one or more resistive heating elements disposed on and/or embedded within the walls of the shaft furnace at least in the reduction zone.
Aspect 26. The method of aspect 24 or 25, wherein electrically heating the shaft furnace comprises heating through induction coils wrapped around the furnace in the at least the reduction zone.
Aspect 27. A method for producing direct reduced iron using a shaft furnace comprising a heating zone, a reduction zone, and a cooling zone, the method comprising:
loading iron ore into a furnace at the heating zone, wherein the iron ore is heated to a target temperature;
flowing a bustle gas comprising hydrogen into the shaft furnace at downstream end of the reduction zone, flows upstream through the reduction zone towards the heating zone;
electrically heating the shaft furnace in at least the reduction zone to a temperature of about 800° C. to about 1100° C.;
flowing the iron ore from the heating zone into the reduction zone, wherein the iron ore is reduced to iron through reaction of the iron ore with the hydrogen in the bustle gas, thereby producing direct reduced iron;
flowing a cooling hydrogen gas into the cooling zone; and
flowing the direct reduced iron from the reduction zone into the cooling zone to cool the direct reduced iron by heat exchange with the cooling hydrogen gas, wherein the cooling hydrogen gas, after heat exchange with the direct reduced iron is flowed into the reduction zone,
wherein hydrogen present in the shaft furnace from the bustle gas and/or the cooling hydrogen gas is flowed from the cooling and/or reduction zones upstream into the heating zone to heat the iron ore through heat exchange before exiting as a top gas.
Aspect 28. The method of aspect 27, wherein electrically heating the shaft furnace comprises one or more resistive heating elements disposed on and/or embedded within the walls of the shaft furnace at least in the reduction zone.
Aspect 29. The method of aspect 27 or 28, wherein electrically heating the shaft furnace comprises heating through induction coils wrapped around the furnace in the at least the reduction zone.
Aspect 30. The method of any one of the preceding aspects, further comprising a plasma generated arranged in the bustle gas inlet stream such that hydrogen plasma is flowed into the shaft furnace.
Aspect 31. The method of any one of the preceding aspects, wherein the bustle gas has a moisture content of about 0% to about 10%.
Aspect 32. The method of any one of the preceding aspects, wherein the iron ore comprises one or more of hematite, magnetite, and wustite.
Aspect 33. The method of any one of the preceding aspects, wherein the iron ore comprises an iron content of at least 66 wt % based on the total weight of the iron ore.
Aspect 34. The method of any one of the preceding aspects, wherein the hydrogen is not premixed with oxygen prior to being flowed into the shaft furnace.
Aspect 35. The method of any one of the preceding aspects, wherein the iron ore has a residence time in the heating zone of about 1 to 4 hours.
Aspect 36. The method of any one of the preceding aspects, wherein the iron ore has a residence time of about 2 to 10 hours in the reduction zone.
Aspect 37. The method of any one of the preceding aspects, wherein the direct reduced iron has a residence time of about 1 to 4 hours in the cooling zone.
Aspect 38. The method of any one of the preceding aspects, wherein the cooling hydrogen is at a temperature of about 0° C. to about 300° C.
Aspect 39. The method of any one of the preceding aspects, further comprising flowing the top gas comprising hydrogen out of the upstream-most end of the furnace; condensing and removing water vapor from the top gas to thereby isolate the hydrogen; and recycling the isolated hydrogen by flowing recycled hydrogen into the bustle gas inlet.
Aspect 40. The method of aspect 39, wherein when the top gas comprises one or more inert gases from the heat carrier gas, the method further comprises separating the inert gas from the hydrogen and recycling the inert gas into the method as heat carrier gas.
Aspect 41. The method of any one of the preceding aspects, wherein the bustle gas comprises hydrogen as the only reducing gas.
Aspect 42. The method of any one of the preceding aspects, wherein the bustle gas consists of hydrogen and optionally one or more inert gases.
Aspect 43. A system for producing direct reduced iron, comprising:
a shaft furnace a heating zone, a reduction zone, and a cooling zone;
an iron ore source in fluid communication with the heating zone to load iron ore into the heating zone;
a bustle gas source for flowing a bustle gas comprising hydrogen into the shaft furnace through a bustle gas inlet disposed at a downstream end of the reduction zone;
an oxygen source for flowing oxygen and/or oxygen enriched gas into the shaft furnace an oxygen inlet disposed upstream of the bustle gas inlet, wherein a portion of the hydrogen flowed into shaft furnace is adapted to combust upon exposure to the oxygen and/or oxygen enriched gas flowed into the shaft furnace and release heat internally within the shaft furnace; and
a cooling hydrogen gas source for flowing cooling hydrogen gas into the shaft furnace through cooling hydrogen gas inlet disposed in the cooling zone, wherein:
the iron ore is adapted to be flowed downstream from the heating zone to the reduction zone, wherein upon interaction with hydrogen in the reduction zone the iron ore is reduced to iron by reaction with the hydrogen and to thereby produce direct reduced iron,
the direct reduced iron produced in the reduction zone is adapted to be flowed downstream to the cooling zone wherein it is cooled by heat exchange with the cooling hydrogen gas, and
hydrogen present in the shaft furnace from the bustle gas and/or the cooling hydrogen gas is adapted to flow from the cooling and/or reduction zones upstream into the heating zone to heat the iron ore through heat exchange before exiting as a top gas.
Aspect 44. The system of aspect 43, further comprising a bustle gas preheating unit arranged between the bustle gas source and the bustle gas inlet to preheat the bustle gas before the bustle gas is flowed into the bustle gas inlet.
Aspect 45. The system of aspect 44, wherein the heating unit is a single stage heating unit.
Aspect 46. The system of aspect 44, wherein the heating unit is multi-stage heating unit.
Aspect 47. The system of any one of aspects 44 to 46, wherein the bustle gas is preheated to a temperature of about 500° C. to about 1100° C.
Aspect 48. The system of any one of aspects 43 to 47, further comprising an electric heater arranged on or within the shaft furnace for heating the shaft furnace in at least the reduction zone.
Aspect 49. The system of aspect 48, wherein electric heater comprises one or more resistive heating elements disposed on and/or embedded within the walls of the shaft furnace at least in the reduction zone.
Aspect 50. The system of aspect 48 or 49 wherein electrically heater comprises induction coils wrapped around the furnace in the at least the reduction zone.
Aspect 51. A system for producing direct reduced iron, comprising:
a shaft furnace a heating zone, a reduction zone, and a cooling zone;
an iron ore source in fluid communication with the heating zone to load iron ore into the heating zone;
a bustle gas source for flowing bustle gas comprising hydrogen into the shaft furnace through a bustle gas inlet disposed at a downstream end of the reduction zone;
optionally a heat carrier gas source for flowing a heat carrier gas comprising an inert gas into the shaft furnace through a heat carrier gas inlet loaded at a downstream end of the reduction zone or through the bustle gas inlet;
a bustle gas preheating unit arranged between the bustle gas source and the bustle gas inlet, wherein the bustle gas preheating unit is adapted to preheat the bustle gas without combustion of the hydrogen to a temperature of about 650° C. to about 1100° C.;
optionally a heat carrier gas inlet arranged between the heat carrier gas source and the heat carrier gas inlet or bustle gas inlet through which the heat carrier gas is flowed into the shaft furnace, wherein the heat carrier gas preheating unit preheats the heat carrier gas to a temperature of about 650° C. to about 1100° C.;
a cooling hydrogen gas source for flowing cooling hydrogen gas into the shaft furnace through cooling hydrogen gas inlet disposed in the cooling zone, wherein:
the iron ore is adapted to be flowed downstream from the heating zone to the reduction zone, wherein upon interaction with hydrogen in the reduction zone the iron ore is reduced to iron by reaction with the hydrogen and to thereby produce direct reduced iron,
the direct reduced iron produced in the reduction zone is adapted to be flowed downstream to the cooling zone wherein it is cooled by heat exchange with the cooling hydrogen gas, and
a molar ratio of H₂:Fe₂O₃ of about 7.4 mol/mol is a minimum hydrogen demand for a target 95% metallization of iron from the iron ore,
when the heat carrier gas is not present, the preheated bustle gas is adapted to be flowed into the shaft furnace such that an amount of hydrogen in the reduction zone is greater than the minimum hydrogen demand,
when the heat carrier gas is present, the bustle gas is flowed into the shaft furnace such that an amount of hydrogen in the reduction zone is equal to or greater than the minimum hydrogen demand, and
hydrogen present in the shaft furnace from the bustle gas and/or cooling hydrogen gas is adapted to flow from the cooling and/or reduction zones upstream into the heating zone to heat the iron ore through heat exchange before exiting as a top gas, and optionally when present, the heat carrier gas is adapted to flow from the reduction zone upstream into the heating zone to heat the iron ore through heat exchange before exiting with the top gas.
Aspect 52. The system of aspect 51, wherein the heat carrier gas is present and is adapted to be premixed with the bustle gas in a premixing unit or in the bustle gas preheating unit before being flowed into the shaft furnace through the bustle gas inlet.
Aspect 53. The system of aspect 51, wherein the heat carrier gas is present and the heat carrier gas is adapted to be preheated by the heat carrier gas preheating unit and then flowed into the shaft furnace through the heat carrier gas inlet.
Aspect 54. The system of aspect 52 or 53, wherein the system is adapted to flow the bustle gas into the shaft furnace such that an amount of hydrogen present in the reduction zone is equal to the minimum hydrogen demand.
Aspect 55. The system of aspect 54, wherein the system is adapted to flow the heat carrier gas into the shaft furnace such that a molar ratio of inert gas:Fe₂O₃ in the reduction zone is 4 mol/mol to 9 mol/mol.
Aspect 56. The system of aspect 52 or 53, wherein the system is adapted to flow the bustle gas into the shaft furnace such that the amount of hydrogen in the reduction zone is greater than the minimum hydrogen demand.
Aspect 57. The system of aspect 56, wherein the system is adapted to flow bustle gas into the shaft furnace such that a molar ratio of H₂:Fe₂O₃ is greater than 6 to 15 mol/mol and the system is adapted to flow heat carrier gas such that a molar ratio of inert gas:Fe₂O₃ is 2 mol/mol to 9 mol/mol.
Aspect 58. The system of any one of aspects 52 to 58, wherein the bustle gas preheating unit comprises at least one electric heater and/or thermal heating.
Aspect 59. The system of any one of aspects 52 to 58, wherein the heat carrier gas preheating unit is present and comprises at least one electric heater and/or thermal heating.
Aspect 60. The system of aspect 58 or 59, wherein the electric heating comprises one or more of a Joule heater, plasma heater, and microwave heater.
Aspect 61. The system of any one of aspects 52 to 60, wherein the system is free of additional heating of the shaft furnace from a source other than the preheated hydrogen.
Aspect 62. The system of any one of aspects 52 to 61, wherein the system is free of an oxygen source for supplying oxygen into the shaft furnace or premixing oxygen with the hydrogen before flowing into the shaft furnace.
Aspect 63. The system of any one of aspects 52 to 60, further comprising at least one electrical heater for electrically heating the shaft furnace in at least the reduction zone.
Aspect 64. The system of aspect 63, wherein the at least one electric heater comprises one or more resistive heating elements disposed on and/or embedded within the walls of the shaft furnace at least in the reduction zone.
Aspect 65. The system of aspect 63 or 64, wherein the at least one electric heater comprises induction coils wrapped around the furnace in the at least the reduction zone.
Aspect 66. The system of any one of aspects 52 to 60, further comprising:
an oxygen source for flowing oxygen and/or oxygen enriched gas into the shaft furnace an oxygen inlet disposed upstream of the bustle gas inlet, wherein a portion of the hydrogen flowed into shaft furnace is adapted to combust upon exposure to the oxygen and/or oxygen enriched gas flowed into the shaft furnace and release heat internally within the shaft furnace.
Aspect 67. The system of aspect 66, further comprising at least one electrical heater for electrically heating the shaft furnace in at least the reduction zone.
Aspect 68. The system of aspect 67, wherein the at least one electric heater comprises one or more resistive heating elements disposed on and/or embedded within the walls of the shaft furnace at least in the reduction zone.
Aspect 69. The system of aspect 67 or 68, wherein at least one electric heater comprises induction coils wrapped around the furnace in the at least the reduction zone.
Aspect 70. A system for producing direct reduced iron, comprising:
a shaft furnace a heating zone, a reduction zone, and a cooling zone;
an electric heater disposed on or integral with the shaft furnace for heating the shaft furnace to a temperature of about 800° C. to about 1100° C. in at least the reduction zone;
an iron ore source in fluid communication with the heating zone to load iron ore into the heating zone;
a bustle gas source for flowing a bustle gas comprising hydrogen into the shaft furnace through a bustle gas inlet disposed at a downstream end of the reduction zone;
a cooling hydrogen gas source for flowing cooling hydrogen gas into the shaft furnace through cooling hydrogen gas inlet disposed in the cooling zone, wherein:
the iron ore is adapted to be flowed downstream from the heating zone to the reduction zone, wherein upon interaction with hydrogen in the reduction zone the iron ore is reduced to iron by reaction with the hydrogen and to thereby produce direct reduced iron,
the direct reduced iron produced in the reduction zone is adapted to be flowed downstream to the cooling zone wherein it is cooled by heat exchange with the cooling hydrogen gas, and
hydrogen present in the shaft furnace from the bustle gas and/or cooling hydrogen gas is adapted to flow from the cooling and/or reduction zones upstream into the heating heat zone to heat the iron ore through heat exchange before exiting as a top gas.
Aspect 71. The system of aspect 70, wherein electric heater comprises one or more resistive heating elements disposed on and/or embedded within the walls of the shaft furnace at least in the reduction zone.
Aspect 72. The system of aspect 70 or 71, wherein electric heater comprises heating through induction coils wrapped around the furnace in the at least the reduction zone.
Aspect 73. The system of any one of aspects 43 to 72, further comprising a hydrogen plasma generator arranged between the bustle gas source and the bustle gas inlet.
Aspect 74. The system of any one of aspects 43 to 73, wherein the hydrogen is not premixed with oxygen prior to being flowed into the shaft furnace.
Aspect 75. The system any one of aspects 43 to 74, further hydrogen cooling unit arranged between the bustle gas source and the cooling hydrogen gas inlet to cool hydrogen from the bustle gas source to a temperature of about 0° C. to about 300° C. to thereby generate the cooling hydrogen.
Aspect 76. The system of any one of aspects 43 to 75, further comprising an electric arc furnace, wherein the cooled direct reduced iron is adapted to be flowed from the cooling zone of the shaft furnace into the electric arc furnace for refining the direct reduced iron into steel.
Aspect 77. The system of any one of aspects 43 to 76, further comprising a top gas recovery unit in fluid communication with the heating zone.
Aspect 78. The system of aspect 77 wherein the top gas recovery unit comprises a condenser for condensing the top gas and removing water vapor from the top gas and recovering hydrogen.
Aspect 79. The system of aspect 77 or 78, wherein the top gas recovery unit is arranged upstream of the bustle gas inlet and arranged to provide recovered hydrogen to the bustle gas inlet.
Aspect 80. The system of claim 79, wherein when the system comprises a bustle gas preheating unit, the top gas recovery unit is arranged upstream of the bustle gas preheating unit and for preheating the recovered hydrogen before being flowed to the bustle gas inlet.
Aspect 81. The system of aspect 79 or 80, wherein when the system comprises a heat carrier gas source, the top gas recover unit is adapted to separate hydrogen from inert gas, wherein inert gas can be recycled through the system with the heat carrier gas.
Aspect 82. The system of any one of aspects 42 to 81, wherein the bustle gas comprises hydrogen as the only reducing gas.
Aspect 83. The system of any one of aspects 42 to 81, wherein the bustle gas consists of hydrogen and optionally inert gas.

### REFERENCES

[1] H. Hamadeh, O. Mirgaux and F. Patisson, “Detailed modeling of the direct reduction of iron ore in a shaft furnace,” vol. 11, no. 10, 10 2018.
[2] H. Hamadeh, “Modélisation mathématique détaillée du procédé de réduction directe du minerai de fer,” 2017.
[3] J. Chipman and S. Marshall, “The Equilibrium Feo+H2=Fe+H2O at Temperatures up to the Melting Point of Iron,” vol. 62, no. 2, pp. 299-305, 2 1940.
[4] W. E. Jominy and D. W. Murphy, “Equilibrium in the Iron-Oxygen-Hydrogen System at Temperatures above 1000° C.,” vol. 23, no. 4, pp. 384-387, 4 1931.
[5] D. J. Gunn, “Transfer of heat or mass to particles in fixed and fluidised beds,” vol. 21, no. 4, pp. 467-476, 1978.
[6] J. Ripke and J. Kopfle, “MIDREX H2: Ultimate Low CO2 Ironmaking and its place in the new Hydrogen Economy,” DIRECT FROM MIDREX, September 2017.

1. A method for producing direct reduced iron (DRI) using a shaft furnace comprising a heating zone, a reduction zone, and a cooling zone, the method comprising:
loading iron ore into a furnace at the heating zone, wherein the iron ore is heated to a target temperature;
flowing a bustle gas comprising hydrogen gas into the furnace through a bustle gas inlet disposed at a downstream end of the reduction zone;
flowing oxygen and/or an oxygen enriched gas into the shaft furnace through an oxygen inlet disposed upstream of the bustle gas inlet, wherein a portion of the hydrogen combusts with the oxygen within the shaft furnace and releases heat internally within the shaft furnace;
flowing the iron ore from the heating zone into the reduction zone, wherein the iron ore is reduced to iron through reaction of the iron ore with the hydrogen, thereby producing direct reduced iron (DRI);
flowing a cooling hydrogen gas into the cooling zone; and
flowing the direct reduced iron (DRI) from the reduction zone into the cooling zone to cool the direct reduced iron by heat exchange with the cooling hydrogen gas, wherein the cooling hydrogen gas, after heat exchange with the direct reduced iron (DRI) flows into the reduction zone,
wherein hydrogen and formed steam present in the shaft furnace from the bustle gas and/or cooling gas flows from the cooling and/or reduction zones upstream into the heating zone to heat the iron ore through heat exchange before exiting as a top gas.

2. The method of claim 1, wherein the oxygen is flowed into the furnace at a rate of about 5 Nm³/MT DRI to about 100 Nm³/MT DRI.

3. The method of claim 1, wherein bustle gas is flowed into the furnace such that H₂ is flowed into the reduction zone to achieve a ratio of H₂:Fe₂O₃ is about 6 to about 15 mol/mol within the reduction zone.

4. A method for producing direct reduced iron (DRI) using a shaft furnace comprising a heating zone, a reduction zone, and a cooling zone, the method comprising:
loading iron ore into a furnace at the heating zone, wherein the iron ore is heated to a target temperature;
flowing a bustle gas comprising hydrogen into the shaft furnace at a downstream end of the reduction zone, wherein the bustle gas is preheated without combustion of the hydrogen to a temperature of about 650° C. to about 1100° C. before being flowed into the shaft furnace, and flows within the shaft furnace through the reduction zone and into the heating zone; optionally flowing a heat carrier gas into the shaft furnace at the downstream end of the reduction zone, wherein the heat carrier gas comprises an inert gas and is preheated to a temperature of about 650° C. to about 1100° C. before being flowed into the shaft furnace;
flowing the iron ore from the heating zone into the reduction zone, wherein the iron ore is reduced to iron through reaction of the iron ore with the preheated bustle gas, thereby producing direct reduced iron (DRI);
flowing a cooling hydrogen gas into the cooling zone; and
flowing the direct reduced iron (DRI) from the reduction zone into the cooling zone to cool the direct reduced iron by heat exchange with the cooling hydrogen gas, wherein the cooling hydrogen gas, after heat exchange with the direct reduced iron (DRI) flows into the reduction zone,
wherein:
a molar ratio of H₂:Fe₂O₃ of about 6 mol/mol is a minimum hydrogen demand for a target 95% metallization of iron from the iron ore,
when the heat carrier gas is not present, the preheated bustle gas is flowed into the shaft furnace such that an amount of hydrogen within the reduction zone is greater than the minimum hydrogen demand,
when the heat carrier gas is present, the bustle gas is flowed into the shaft furnace such that an amount of hydrogen within the reduction zone is equal to or greater than the minimum hydrogen demand,
and
wherein hydrogen present in the shaft furnace flows from the cooling and/or reduction zones upstream into the heating zone to heat the iron ore through heat exchange before exiting as a top gas, and optionally, when present, the heat carrier gas flows from the reduction zone upstream into the heating zone to heat the iron ore through heat exchange before exiting with the top gas.

5. The method of claim 4, wherein the heat carrier gas is present and is premixed with the bustle gas before being flowed into the shaft furnace.

6. The method of claim 4, wherein the heat carrier gas is present and the heat carrier gas is flowed into the shaft furnace through a heat carrier gas inlet.

7. The method of any one of claim 4, comprising flowing the bustle gas into the shaft furnace such that the amount of hydrogen within the reduction zone is equal to the minimum hydrogen demand.

8. The method of claim 7, wherein the inert gas is N₂ and the method comprising flowing heat carrier gas into the reduction zone such that a molar ratio of inert gas:Fe₂O₃ is 4 mol/mol to 9 mol/mol.

9. The method of claim 4, comprising flowing the bustle gas into the shaft furnace such that the amount hydrogen within the reduction zone is greater than the minimum hydrogen demand.

10. The method of claim 9, comprising flowing the bustle gas into the shaft furnace such that a molar ratio of H₂:Fe₂O₃ within the reduction zone is greater than 6 mol/mol to 15 mol/mol; and flowing the heat carrier gas into the shaft furnace such that a molar ratio of inert gas:Fe₂O₃ is 2 mol/mol to 9 mol/mol.

11. The method of claim 4, comprising preheating the bustle gas and the heat carrier gas, when present, by one or more stages of electric heating and/or thermal heating.

12. The method of claim 11, wherein the thermal heating comprises nuclear reactor thermal output, heat pump, or waste heat from other sources.

13. The method of claim 4, wherein the method is free of additional heating of the shaft furnace from a source other than the preheated bustle gas and, when present, the heat carrier gas.

14. The method of claim 4, wherein the method is free from flowing oxygen into the shaft furnace.

15. A system for producing direct reduced iron, comprising:
a shaft furnace a heating zone, a reduction zone, and a cooling zone;
an iron ore source in fluid communication with the heating zone to load iron ore into the heating zone;
a bustle gas source for flowing bustle gas comprising hydrogen into the shaft furnace through a bustle gas inlet disposed at a downstream end of the reduction zone;
optionally a heat carrier gas source for flowing a heat carrier gas comprising an inert gas into the shaft furnace through a heat carrier gas inlet loaded at a downstream end of the reduction zone or through the bustle gas inlet;
a bustle gas preheating unit arranged between the bustle gas source and the bustle gas inlet, wherein the bustle gas preheating unit is adapted to preheat the bustle gas without combustion of the hydrogen to a temperature of about 650° C. to about 1100° C.;
optionally a heat carrier gas inlet arranged between the heat carrier gas source and the heat carrier gas inlet or bustle gas inlet through which the heat carrier gas is flowed into the shaft furnace, wherein the heat carrier gas preheating unit preheats the heat carrier gas to a temperature of about 650° C. to about 1100° C.;
a cooling hydrogen gas source for flowing cooling hydrogen gas into the shaft furnace through cooling hydrogen gas inlet disposed in the cooling zone, wherein:
the iron ore is adapted to be flowed downstream from the heating zone to the reduction zone, wherein upon interaction with hydrogen in the reduction zone the iron ore is reduced to iron by reaction with the hydrogen and to thereby produce direct reduced iron,
the direct reduced iron produced in the reduction zone is adapted to be flowed downstream to the cooling zone wherein it is cooled by heat exchange with the cooling hydrogen gas, and
a molar ratio of H₂:Fe₂O₃ of about 6 mol/mol is a minimum hydrogen demand for a target 95% metallization of iron from the iron ore,
when the heat carrier gas is not present, the preheated bustle gas is adapted to be flowed into the shaft furnace such that an amount of hydrogen in the reduction zone is greater than the minimum hydrogen demand,
when the heat carrier gas is present, the bustle gas is flowed into the shaft furnace such that an amount of hydrogen in the reduction zone is equal to or greater than the minimum hydrogen demand, and
hydrogen present in the shaft furnace from the bustle gas and/or cooling hydrogen gas is adapted to flow from the cooling and/or reduction zones upstream into the heating zone to heat the iron ore through heat exchange before exiting as a top gas, and optionally when present, the heat carrier gas is adapted to flow from the reduction zone upstream into the heating zone to heat the iron ore through heat exchange before exiting with the top gas.

16. The system of claim 15, wherein the heat carrier gas is present and is adapted to be premixed with the bustle gas in a premixing unit or in the bustle gas preheating unit before being flowed into the shaft furnace through the bustle gas inlet.

17. The system of claim 15, wherein the heat carrier gas is present and the heat carrier gas is adapted to be preheated by the heat carrier gas preheating unit and then flowed into the shaft furnace through the heat carrier gas inlet.

18. The system of claim 15, wherein the system is adapted to flow the bustle gas into the shaft furnace such that an amount of hydrogen present in the reduction zone is equal to the minimum hydrogen demand.

19. The system of claim 15, wherein the system is adapted to flow the bustle gas into the shaft furnace such that the amount of hydrogen in the reduction zone is greater than the minimum hydrogen demand.

20. The system of claim 15, wherein the system is free of an oxygen source for supplying oxygen into the shaft furnace or premixing oxygen with the hydrogen before flowing into the shaft furnace.
